(19) United States
(12) Patent Application Publication
(10) Pub. No.: US 2012/0100911 A1
(43) Pub. Date: Apr. 26, 2012

(54) SYSTEM AND METHOD FOR SIMULATING EVENTS IN A REAL ENVIRONMENT

(75) Inventor: Juan Manuel Rejen, Zwijndrecht (NL)

(73) Assignee: Iopener Media GmbH

(21) Appl. No.: 13/120,148

(22) PCT Filed: Sep. 24, 2009
(86) PCT No.: PCT/IB2009/006924

§ 371 Date: Jan. 5, 2012

Related U.S. Application Data
(60) Provisional application No. 61/099,697, filed on Sep. 24, 2008.

(51) Int. Cl. A63F 13/00

(52) U.S. Cl. 463/31

(57) ABSTRACT

Described are computer-based methods and apparatuses, including computer program products, for simulating events in a real environment. In some example, the simulating events in a real environment includes a method. The method includes determining a user location of a user-controlled object in a virtual environment. The method further includes determining a virtual location of a real-data object in the virtual environment relative to the user location based on a real location of the real-data object in the real environment. The method further includes controlling a present virtual location of the real-data object in the virtual environment based on the virtual location and one or more saved real locations associated with the real-data object.

### RELATED APPLICATION

This application claims the benefit of and priority to U.S. Provisional Application No. 61/099,697, filed on Sep. 24, 2008, the entire teachings of the above application are incorporated herein by reference.

### FIELD OF THE INVENTION

The present invention relates generally to computer-based methods and apparatuses, including computer program products, for simulating events in a real environment.

### BACKGROUND

Today's computer games are more and more focused on realism and strive for extending the connection between reality and the game world. One way of achieving this consists of the seamless integration of real-world objects into a game's virtual environment. For example, a player is sitting at home playing a car racing game; however, the opponents in that race (rather than non-player characters) are avatars of real cars, driven by real pilots who, at the very same moment, are racing in a real circuit somewhere in the real world. The real-time participation in a real-world race is challenging due to the unpredictability of the actions of the real world players.

Thus, there is a need in the field for techniques to integrate reality with the game world to achieve the optimal gaming experience for the user.

### SUMMARY OF THE INVENTION

One approach to simulating events in a real environment is a method. The method includes determining a user location of a user-controlled object in a virtual environment; determining a virtual location of a real-data object in the virtual environment relative to the user location based on a real location of the real-data object in the real environment; and controlling a present virtual location of the real-data object in the virtual environment based on the virtual location and one or more saved real locations associated with the real-data object.

Another approach to simulating events in a real environment is a method. The method includes determining a projected intersect between one or more real-world objects and one or more virtual objects in a virtual environment; and determining an alternative location for each real-world object projected to intersect with at least one virtual object based on the projected intersect between the one or more real-world objects and the one or more virtual objects.

Another approach to simulating events in a real environment is a method. The method includes identifying a virtual location and a real-world location for a real-world object; identifying a virtual location for a virtual object; determining a projected intersect for the real-world object and the virtual object based on the virtual location for the real-world object, the real-world location for the real-world object, the virtual location for the virtual object, or any combination thereof; and modifying the virtual location for the real-world object based on the projected intersect and one or more stored virtual locations associated with the real-world object.

Another approach to simulating events in a real environment is a computer program product. The computer program product is tangibly embodied in an information carrier and includes instructions being operable to cause a data processing apparatus to determine a user location of a user-controlled object in a virtual environment; determine a virtual location of a real-data object in the virtual environment relative to the user location based on a real location of the real-data object in the real environment; and control a present virtual location of the real-data object in the virtual environment based on the virtual location and one or more saved real locations associated with the real-data object.

Another approach to simulating events in a real environment is a system. The system includes a virtual-data location module configured to determine a user location of a user-controlled object in a virtual environment; a real-data location module configured to determine a virtual location of a real-data object in the virtual environment relative to the user location based on a real location of the real-data object in the real environment; and a location control module configured to control a present virtual location of the real-data object in the virtual environment based on the virtual location and one or more saved real locations associated with the real-data object.

Another approach to simulating events in a real environment is a system. The system includes a real-data location module configured to identify a virtual location and a real-world location for a real-world object; a virtual-data location module configured to identify a virtual location for a virtual object; a location projection module configured to determine a projected intersect for the real-world object and the virtual object based on the virtual location for the real-world object, the real-world location, the virtual location for the virtual object, or any combination thereof; and a location control module configured to modify the virtual location for the real-world object based on the projected intersect and one or more stored virtual locations associated with the real-world object.

Another approach to simulating events in a real environment is a system. The system includes means for determining a user location of a user-controlled object in a virtual environment; means for determining a virtual location of a real-data object in the virtual environment relative to the user location based on a real location of the real-data object in the real environment; and means for controlling a present virtual location of the real-data object in the virtual environment based on the virtual location and one or more saved real locations associated with the real-data object.

In other examples, any of the approaches above can include one or more of the following features.

In some examples, the method further includes determining if a next real location of the real-data object is available; and controlling the present virtual location of the real-data object in the virtual environment based on a pre-defined path associated with the real environment and the determination if the next real location of the real-data object is available.

In other examples, the method further includes determining if an additional real location of the real-data object is available; identifying a next user location of the user-controlled object in the virtual environment; determining one or more future virtual locations of the real-data object in the virtual environment based on the determination if the additional real location of the real-data object is available and the next user location, the one or more future virtual locations associated with a path to move the present virtual location to a virtual location associated with the additional real location; and controlling the present virtual location of the real-data object in the virtual environment based on the one or more future virtual locations.

In some examples, the method further includes identifying a next user location of the user-controlled object in the virtual environment; determining a next virtual location of the real-data object in the virtual environment based on a next real location of the real-data object in the real environment; and controlling the present virtual location of the real-data object based on the next virtual location and a realistic distance between the next virtual location and the next user location.

In other examples, the method further includes determining an additional virtual location of the real-data object in the virtual environment based on the one or more saved real locations.

In some examples, the method further includes identifying an additional user location of the user-controlled object in the virtual environment; determining a virtual location of a next real-data object in the virtual environment based on a real location of the next real-data object in the real environment; and controlling a present virtual location of the next real-data object in the virtual environment based on the virtual location, a realistic distance between the virtual location and the additional user location of the user-controlled object, and a time sequence identification associated with the next virtual location of the real-data object.

In other examples, the method further includes determining an additional virtual location of the real-data object in the virtual environment based on the one or more saved locations, the additional virtual location associated with a next time sequence identification; and determining a next virtual location of the next real-data object in the virtual environment based on one or more next saved locations and the next time sequence identification.

In some examples, the method further includes determining a next virtual location of the real-data object in the virtual environment based on a next real location of the real-data object in the real environment, the next virtual location being different than the next real location and in front of the user-controlled object; and controlling the present virtual location of the real-data object based on the next virtual location of the real-data object.

In other examples, the virtual location of the real-data object in the virtual environment is different than the real location of the real-data object in the real environment.

In some examples, the method further includes determining a virtual location of a next real-data object in the virtual environment relative to the user location of the user-controlled object in the virtual environment based on a real location of the next real-data object in the real environment; and controlling a present virtual location of the next real-data object in the virtual environment based on the virtual location and one or more saved real locations associated with the next real-data object.

In other examples, wherein the determining the virtual location occurs in real-time or near real-time with a movement of the real-data object in the real environment.

In some examples, the method further includes positioning each real-world object projected to interest in the respective alternative location.

In other examples, the method further includes determining if a location is missing for the one or more real-world objects; and determining a missed location for each real-world object missing data based on one or more saved locations associated with the respective real-world object.

In some examples, the system further include the real-data location module further configured to determine if a next real location of the real-data object is available; and the location control module further configured to control the present virtual location of the real-data object in the virtual environment based on a pre-defined path associated with the real environment and the determination if the next real location of the real-data object is available.

In other examples, the system further includes the real-data location module further configured to determine if an additional real location of the real-data object is available; the virtual-data location module further configured to identify a next user location of the user-controlled object in the virtual environment; a location projection module configured to determine one or more future virtual locations of the real-data object in the virtual environment based on the determination if the additional real location of the real-data object is available and the next user location, the one or more future virtual locations associated with a path to move the present virtual location to a virtual location associated with the additional real location; and the location control module further configured to control the present virtual location of the real-data object in the virtual environment based on the one or more future virtual locations.

In some examples, the system further includes the virtual-data location module further configured to identify a next user location of the user-controlled object in the virtual environment; the real-data location module further configured to determine a next virtual location of the real-data object in the virtual environment based on a next real location of the real-data object in the real environment; and the location control module further configured to control the present virtual location of the real-data object based on the next virtual location and a realistic distance between the next virtual location and the next user location.

In other examples, the system further includes the real-data location module further configured to determine an additional virtual location of the real-data object in the virtual environment based on the one or more saved real locations.

In some examples, the system further includes the virtual-data location module further configured to identify an additional user location of the user-controlled object in the virtual environment; the real-data location module further configured to determine a virtual location of a next real-data object in the virtual environment based on a real location of the next real-data object in the real environment; and the location control module further configured to control a present virtual location of the next real-data object in the virtual environment based on the virtual location, a realistic distance between the virtual location and the additional user location of the user-controlled object, and a time sequence identification associated with the next virtual location of the real-data object.

In other examples, the system further includes the real-data location module further configured to determine an additional virtual location of the real-data object in the virtual environment based on the one or more saved locations, the additional virtual location associated with a next time sequence identification; and determine a next virtual location of the next real-data object in the virtual environment based on one or more next saved locations and the next time sequence identification.

In some examples, the system further includes the real-data location module further configured to determine a next virtual location of the real-data object in the virtual environment based on a next real location of the real-data object in the real environment, the next virtual location being different than the next real location and in front of the user-controlled object; and the location control module further configured to control the present virtual location of the real-data object based on the next virtual location of the real-data object.

In other examples, the system further includes the real-data location module further configured to determine a virtual location of a next real-data object in the virtual environment relative to the user location of the user-controlled object in the virtual environment based on an next real location of the next real-data object in the real environment; and the location control module further configured to control a present virtual location of the next real-data object in the virtual environment based on the virtual location and one or more saved real locations associated with the next real-data object.

In some examples, the system further includes a location intersect module configured to determine a projected intersect between one or more real-world objects and one or more virtual objects in a virtual environment; and a location projection module configured to determine an alternative location for each real-world object projected to intersect with at least one virtual object based on the projected intersect between the one or more real-world objects and the one or more virtual objects.

In other examples, the system further includes a location control module configured to position each real-world object projected to interest in the respective alternative location.

In some examples, the system further includes a real-data location module configured to determine if a location is missing for the one or more real-world objects; and the location projection module further configured to determine a missed location for each real-world object missing data based on one or more saved locations associated with the respective real-world object.

The simulating events in a real environment techniques described herein can provide one or more of the following advantages. An advantage to the simulation of the events is that an illusion of realism, i.e., believability, can be maintained by the implementation of the techniques described herein, thereby increasing the quality of the game experience for the user. Another advantage to the simulation of the events is that the implementation of the techniques described herein can occur in real-time to ensure that the data presented to the user corresponds with the real-world data, thereby increasing the quality of the game experience for the user.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a diagram of exemplary game system;

FIG. 2 is a diagram of another exemplary game system;

FIG. 3 is a block diagram of an exemplary game server;

FIG. 4 is a flowchart of exemplary game processing;

FIG. 5 is another flowchart of exemplary game processing;

FIG. 6 is another flowchart of exemplary game processing for collision avoidance;

FIG. 7 is a diagram of exemplary objects in an exemplary game system;

FIG. 8 is another diagram of exemplary objects in an exemplary game system;

FIG. 9 is another flowchart of exemplary game processing;

FIG. 10 is another diagram of exemplary objects in an exemplary game system;

FIG. 11 is another diagram of exemplary objects in an exemplary game system;

FIG. 12 is another flowchart of exemplary game processing;

FIG. 13 is a screenshot of exemplary objects in an another exemplary game system;

FIG. 14 is another screenshot of exemplary objects in an another exemplary game system;

FIG. 15 is another screenshot of exemplary objects in an another exemplary game system;

FIG. 16 is another screenshot of exemplary objects in an another exemplary game system;

FIG. 17 is another screenshot of exemplary objects in an another exemplary game system;

FIG. 18 is another screenshot of exemplary objects in an another exemplary game system;

FIG. 19 is another screenshot of exemplary objects in an another exemplary game system;

FIG. 20 is another screenshot of exemplary objects in an another exemplary game system;

FIG. 21 is another screenshot of exemplary objects in an another exemplary game system;

FIG. 22 is another screenshot of exemplary objects in an another exemplary game system;

FIG. 23 is another screenshot of exemplary objects in an another exemplary game system;

FIG. 24 is another screenshot of exemplary objects in an another exemplary game system;

FIG. 25 is another screenshot of exemplary objects in an another exemplary game system;

FIG. 26 is a diagram of another exemplary game system;

FIG. 27 is another flowchart of exemplary game processing; and

FIG. 28 is another flowchart of exemplary game processing.

### DETAILED DESCRIPTION

In general overview, today's computer games are more and more focused on realism and strive for extending the connection between reality and the game world. An example of extending the realism is the seamless integration of real-world objects into a game's virtual environment. For example, a user is sitting at home playing a car racing game; however, the opponents in that race (rather than non-player characters) are avatars of real cars, driven by real pilots who, at the very same moment, are racing in a real circuit somewhere in the real world. The system enables the real-time participate in a real-world race, i.e., one that is actually taking place somewhere else in the world. Although a real-time racing game is the example herewithin, other events, sports, and/or games can utilize the system to integrate real-world objects into a virtual environment.

As a further general overview of the system for simulating events in a real environment, the system captures information from a physical event (e.g., car race, athletic event, etc.) in which real-world objects (e.g., car, human, bulldozer, etc.) interact with a surrounding environment and with each other. The system generates a virtual representation of the physical event, including a virtual representation of the real-world objects, and allows an end user to participate in the virtual representation through insertion of a virtual object (e.g., computer simulation, computer game, etc.). The system can advantageously capture state information from the event to make the virtual representation of the event as realistic as possible. The end user utilizes controls (e.g., keyboard, mouse, joystick, steering wheel, etc.) to manipulate the virtual object within the virtual representation.

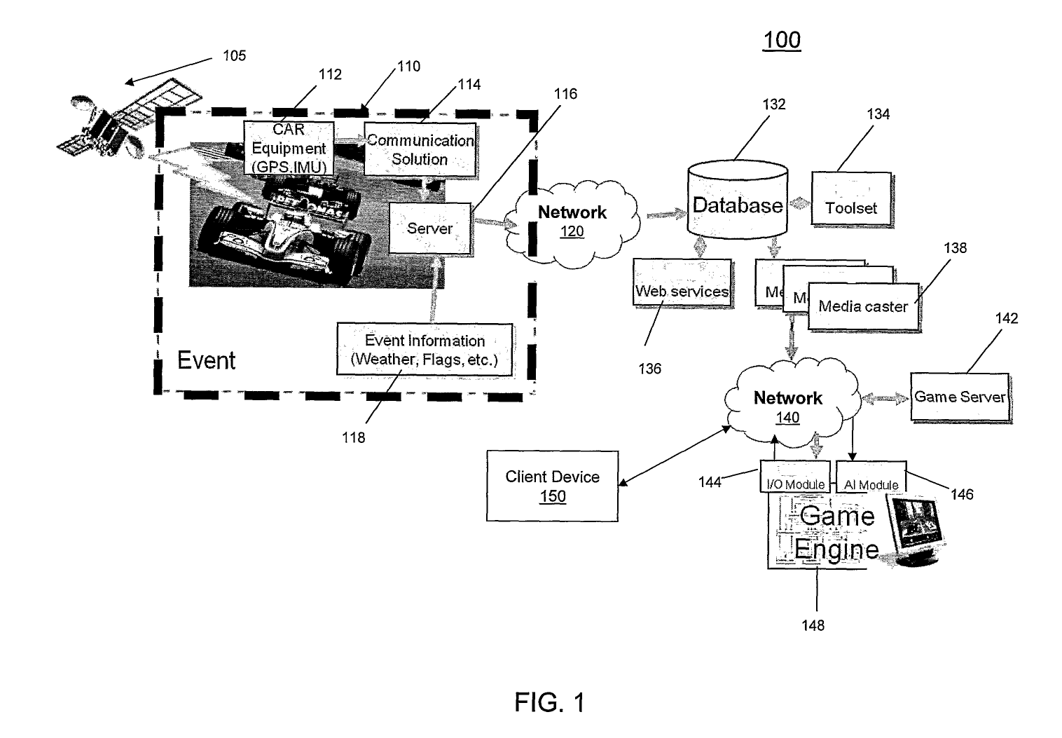

FIG. 1 is a diagram of an exemplary game system 100 for an auto racing example. The system 100 includes a car equipment 112 (e.g., a GPS receiver) positioned on the real-world car (i.e., dynamic object). For example, the GPS receiver 112 receives signals from multiple GPS satellites 105 and formulates a position of the car periodically throughout a race event 110. The car may be configured with other equipment 112 as shown, such as an inertial measurement unit (IMU), telemetry, a mobile radio, and/or other types of communication (e.g., WiMAX, CDMA, etc.). A base station 114, i.e., a communication solution, is also provided locally forming a radio (communication) link with the car's mobile radio. The base station 114 receives information from the car and relays it to a networked server 116. The server 116 can communicate the information from the car to a database 132 via the network 120.

The radio transmitter sends position information and any other telemetry data that may be gathered from the dynamic object to the radio base station 114. Preferably, the position information is updated rapidly, such as a rate of at least 30 Hz. However, the latency in the system 100 is not the delay in the radio communication the delay between the actual event 110 and the representation in a client device 150.

Other event information 118, such as weather, flags, etc., are transmitted to the network server 116 from an event information system (not shown). The server 116 can communicate the event information to the database 132 via the network 120.

The radio messages for each of the different dynamic vehicles are preferably discernable from each other and may be separated in time or frequency. The communication between the car and the base station 114 is not limited to radio communication but can also be covered by other types of communication (e.g., Wifi, WiMAX, infrared light, laser, etc.).

An event toolset 134 processes the database 132 to normalize data and/or to identify event scenarios. Web services 136 provide a web interface for searching and/or analyzing the database 132. One or more media casters 138 process the database 132 to provide real-time or near real-time data streams for the real-world events to a game server 142, a game engine 148, and/or a client device 150. The game server 142 can process the data streams and provide simulated events to a plurality of users. The client device 150 can process the data stream and provide a simulated event to a user.

The game engine 148 receives a data stream from a media caster 138 via an input/output module 144 and/or an artificial intelligence (AI) module 146. The game engine 148 processes the data stream and provides a simulated event to a user.

Although FIG. 1 refers to auto racing, the technology is applicable to virtually any competitive event in which a virtual user can participate in a virtual representation of a real world competitive event (e.g., a sport, a game, derby cars, a boat race, a horse race, a motorcycle race, a bike race, etc.).

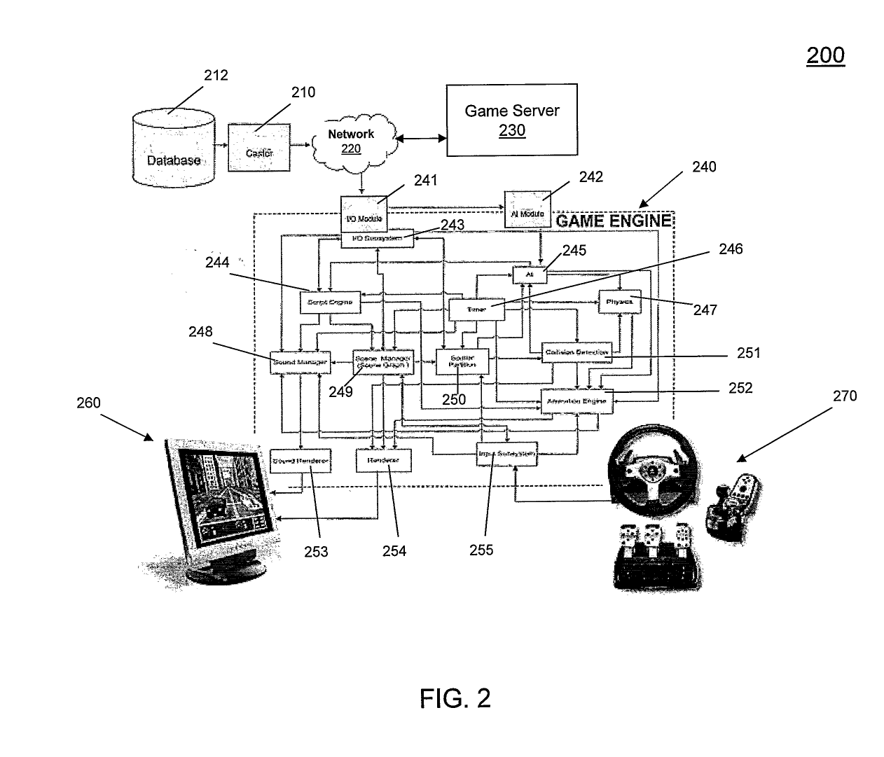

FIG. 2 is a diagram of another exemplary game system 200. The system 200 includes a media caster 210, a database 212 connected to the media caster 210, a network 220, a game server 230, and a game engine 240.

The game engine 240 includes an input/output module 241 and an input/output subsystem 243 for sending and receiving information to and from the networked game server 230 via the network 220. The game engine 140 also includes an input subsystem 255 for receiving user input from user controls 270 (e.g., joystick, keyboard, mouse, etc.) and an Artificial Intelligence (AI) subsystem 245 (e.g., determine paths around a projected intersect, determine path to return to current real-world position, etc.).

Other subsystems or modules of the game engine 240 include a script engine 244 (e.g., executes scripts associated with the virtual environment, etc.), a timer 246, a physics engine 247 (e.g., ensures that objects in the virtual environment abide by the physical restraints of a real-world, ensures realism by enforcing rules, etc.), a sound manager 248, a scene manager 249, a spatial portioning module 250, a collision detection module 251 (e.g., detects potential collisions, etc.), an animation engine 252, a sound renderer 253, and a graphics renderer 254. The game engine 240 stores game data, receives in-game parameters of real-world objects from the networked server 230, and receives in-game data from the AI module 245, as well as data from other sources, such as user input, received through user controls 270. The game engine 240 also reads locally stored data, communicates with the game server 230, and generates graphics, sounds, and other feedback, indicative of the virtual representation of the physical event, including a virtual object. The graphics, sounds, and other feedback are rendered by the game engine 240 on a user display 260.

The system 200 can process amateur competitor performance information, but does not forward such data directly or indirectly to either the networked server 230, or the media center. To the extent the system 200 relies upon any Web-hosted applications, such applications will be downloaded to the end-user client from the Web prior to use, such that any rendering of display images would be produced at the end user console and not at a Web server.

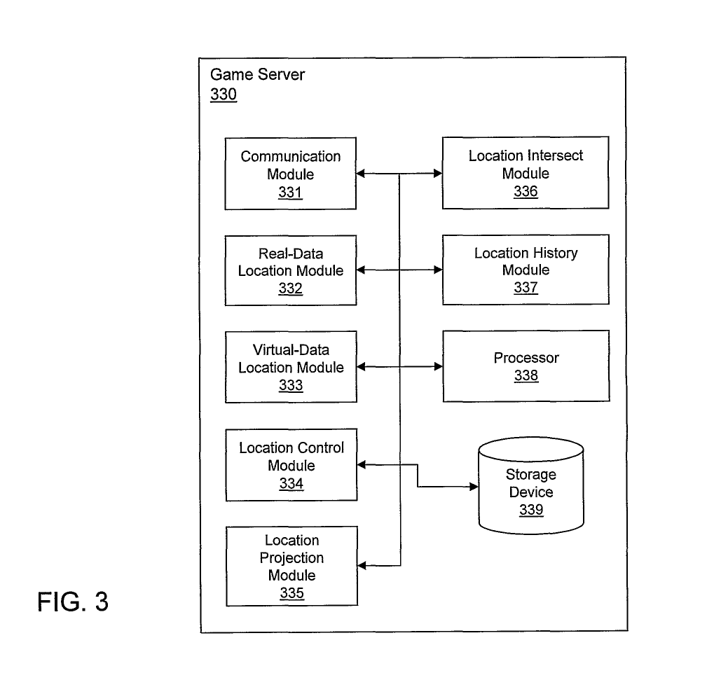

FIG. 3 is a block diagram of an exemplary game server 330. The game server 330 includes a communication module 331, a real-data location module 332, a virtual-data location module 333, a location control module 334, a location projection module 335, a location intersect module 336, a location history module 337, a processor 338, and a storage device 339. The game server 330 includes various modules and/or devices utilized to operate the game server 330. The modules and/or devices can be hardware and/or software. The modules and/or devices illustrated in the game server 330 can, for example, utilize the processor to execute computer executable instructions and/or include a processor to execute computer executable instructions (e.g., an encryption processing unit, a field programmable gate array processing unit, etc.). It should be understood that the game server 330 can include, for example, other modules, devices, and/or processors known in the art and/or varieties of the illustrated modules, devices, and/or processors.

The communication module 331 communicates information and/or data to/from the game server 330. The real-data location module 332 determines a virtual location of a real-data object in the virtual environment relative to the user location based on a real location of the real-data object in the real environment. The real-data location module 332 can determine if a next real location of the real-data object is available (e.g., determine if the data transmissions from the real-data object have stopped, determine if there is not an incoming data transmission from the real-data object, etc.). In some examples, the virtual location is associated with a time sequence identification (e.g., time=4:34.23; time=45, etc.). In other examples, the real-data location module 332 determines the virtual location of the real-data object based on one or more saved locations and the time sequence identification. The real-data location module 332 can determine if a location is missing for the one or more real-world objects.

The virtual-data location module 333 determines a user location of a user-controlled object in a virtual environment. The virtual-data location module 333 can identify a next user location of the user-controlled object in the virtual environment.

The location control module 334 controls a present virtual location of the real-data object in the virtual environment based on the virtual location and one or more saved real locations associated with the real-data object. The location control module 334 can control the present virtual location of the real-data object in the virtual environment based on a pre-defined path associated with the real environment and the determination if the next real location of the real-data object is available. The location control module 334 can control the present virtual location of the real-data object in the virtual environment based on one or more future virtual locations. The location control module 334 can control the present virtual location of the real-data object based on the virtual location and a realistic distance between the virtual location and the user location.

The location projection module 335 determines one or more future virtual locations of the real-data object in the virtual environment based on the determination if the additional real location of the real-data object is available and the next user location. The one or more future virtual locations can be associated with a path to move the present virtual location to a virtual location associated with the additional real location.

The location intersect module 336 determines a projected intersect between one or more real-world objects and one or more virtual objects in a virtual environment. The location history module 337 stores the locations of one or more real-data objects and/or one or more user-controlled objects. The processor 338 executes the operating system and/or any other computer executable instructions for the game server 330.

The storage device 339 stores the systems described herein and/or any other data associated with the game server 330. The storage device 339 can include a plurality of storage devices. The storage device 339 can include, for example, long-term storage (e.g., a hard drive, a tape storage device, flash memory, etc.), short-term storage (e.g., a random access memory, a graphics memory, etc.), and/or any other type of computer readable storage.

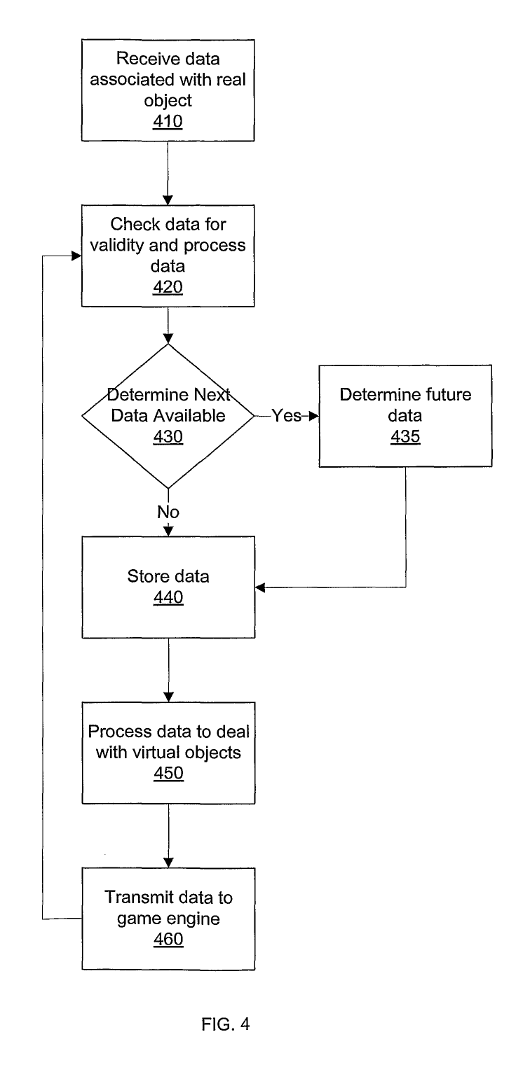

FIG. 4 is a flowchart 400 of exemplary game processing utilizing, for example, the game server 330 of FIG. 3. The communication module 331 receives (410) data associated with a real-data object. The real-data location module 332 checks (420) the data for validity (e.g., correct format, correct parameters, etc.) and processes the data (e.g., converts the data to an internal storage format, converts the measurements to standard measurements, etc.). The real-data location module 332 determines (430) if the next real location of the real-data object is available (e.g., missing data, needed data, etc.). If the next data is not available, the location projection module 335 determines (435) one or more future virtual locations for the real-data object (e.g., via interpolation, via extrapolation, via projection, etc.). If the next data is available, the location history module 337 stores (440) the data. The location control module 334 processes (450) the data to modify the virtual location for the real-world objects in the virtual environment. The communication module 331 transmits (460) the data including the modified virtual location to the game engine 240 of FIG. 2.

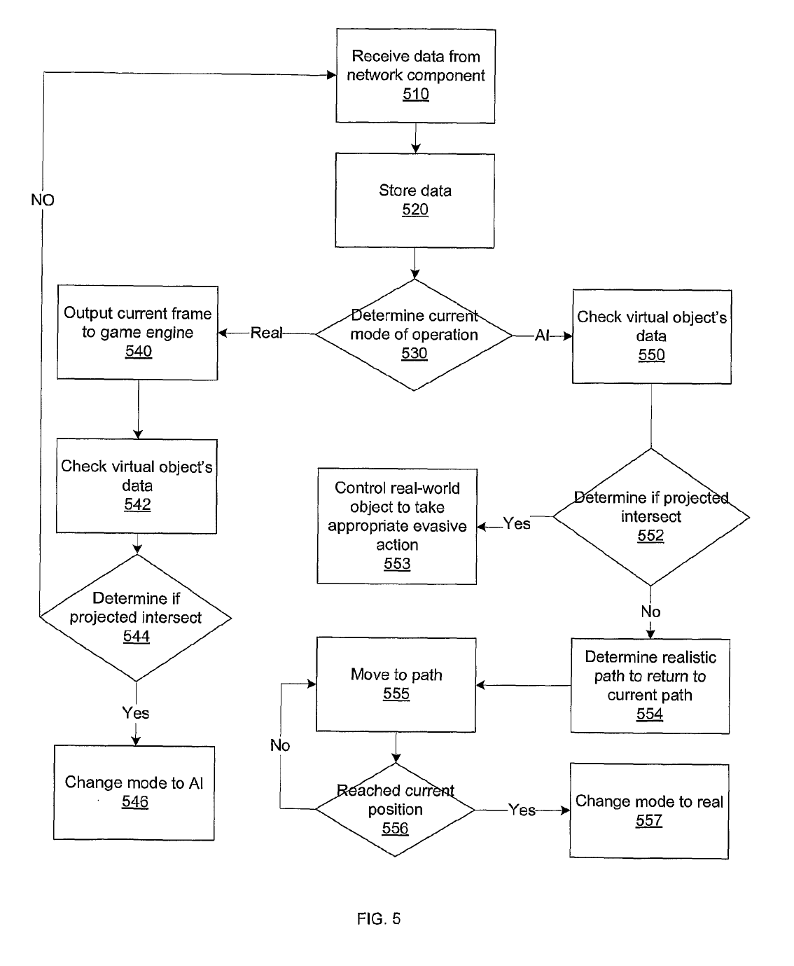

FIG. 5 is another flowchart 500 of exemplary game processing utilizing, for example, the game server 330 of FIG. 3. The communication module 331 receives (510) data from one or more network components (e.g., the database 132 of FIG. 1, the one or more media casters 138, etc.). The location history module 337 stores (520) the data in the storage device 339. The real-data location module 332 determines (530) the current mode of operation for the simulated event.

If the current mode of operation is real, the communication module 331 outputs (540) the current frame to the game engine 148 of FIG. 1. The virtual-data location module 333 checks (542) the virtual object's data (e.g., identifies the location of the virtual object, identifies the heading of the virtual objects, etc.). The location intersect module 336 determines (544) if there is a projected intersect between the virtual object and the real-world object. If there is not a projected intersect, the processing of incoming data continues. If there is a projected intersect, the game server 330 changes (546) the operation mode to AI.

If the current mode of operation is AI, the real-data location module 332 checks (550) the virtual object's data (e.g., checks to ensure that the data is accurate, checks to ensure that the data is complete, etc.). The location intersect module 336 determines (552) if there is still a projected intersect between the virtual object and the real-world object. If there is still a projected intersect, the location control module 334 controls (553) the real-world object in the virtual environment to take the appropriate evasive action. If there is not a projected intersect, the location projection module 335 determines (554) a realistic path to return the virtual location of the real-world object to its real-world location in the virtual environment. The location control module 334 moves (555) the virtual location of the real-world object based on the path. The location control module 334 determines (556) if the virtual location is the current real location of the real-world object. If the virtual location does not match the physical location, the location control module 334 continues moving the virtual location of the real-world object based on the path. If the virtual location matches the physical location, the game server 330 changes (557) mode to real.

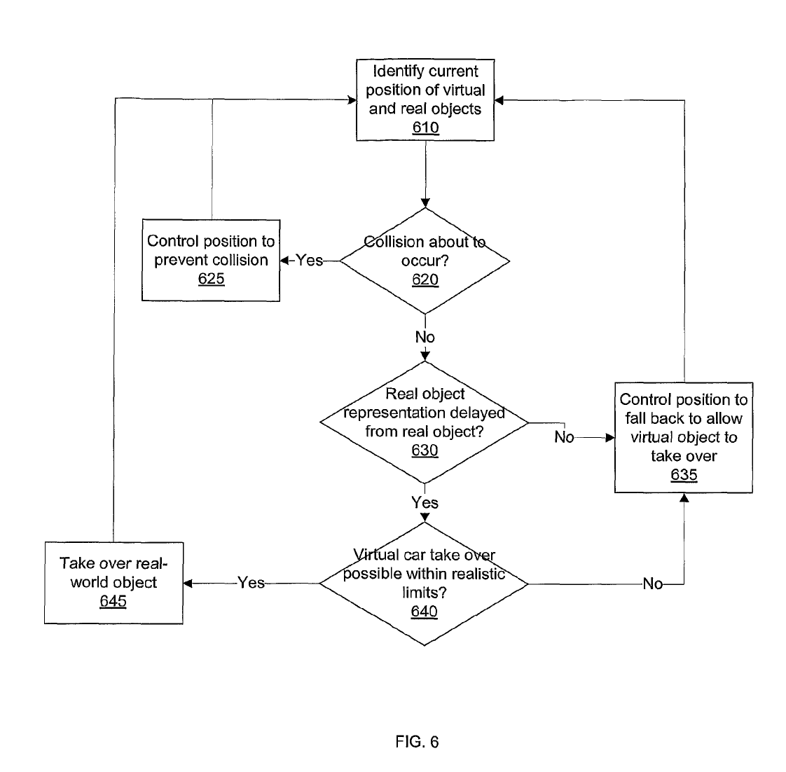

FIG. 6 is another flowchart 600 of exemplary game processing for collision avoidance utilizing, for example, the game server 330 of FIG. 3. The real-data location module 332 identifies (610) the current location of the real-world object and the virtual-data location module 333 identifies (610) the current location of the virtual object. The location projection module 335 determines (620) if a collision is about to occur based on the current locations of the real-world object and the virtual object (e.g., within a set distance, etc.). If a collision is about to occur, the location control module 334 controls (625) the position of the real-world object to prevent the collision. If a collision is not about to occur, the real-data location module 332 determines (630) if the virtual location of the real-world object is delayed form the real location of the real-world object.

If the virtual location is not delayed from the real location, the location control module 334 controls (635) the virtual location of the real-world object to allow the virtual object to take over the virtual location of the real-world object. If the virtual location is delayed from the real location, the virtual-data location module 333 determines (640) if a over take of the virtual object by the real-world object is possible. If the over take is possible, the location control module 334 takes (645) over control of the virtual location of the real-world object to avoid the collision. If the over take is not possible, the location control module 334 controls (635) the virtual location of the real-world object to allow the virtual object to take over the virtual location of the real-world object.

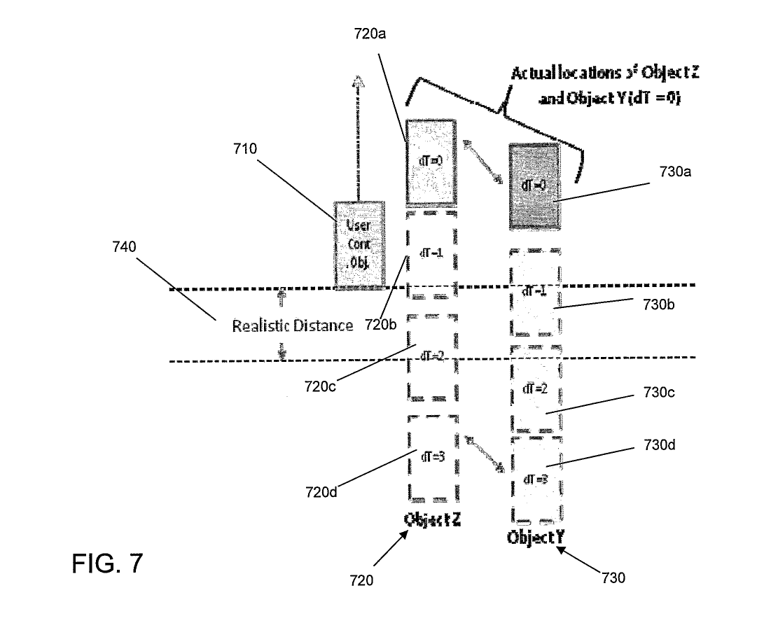

FIG. 7 is a diagram of exemplary objects 710, 720a, and 730a in an exemplary game system and illustrates an overtake of real-data objects 720a and 730a by an user-controlled object 710. As illustrated, each real-data object 720a and 730a includes a history of one or more previous locations 720 (i.e., 720b, 720c, and 720d) and 730 (i.e., 730b, 730c, and 730d), respectively. When the user-controlled object 710 overtakes the real-data objects 720a and 730a, the real-data objects 720a and 730a are positioned at a location within their respective history but beyond a realistic distance 740. In this example, each real-data object 720a and 730a is positioned in a location based on the history and a time sequence for the corresponding real-data object. For example, if the real-data object 720a is positioned at location 720d, time position=3, the real-data object 730a is positioned at location 730d, time position=3. In this example, the time positions for the real-data objects 720a and 730a that the user-controlled object 710 is overtaking are the same.

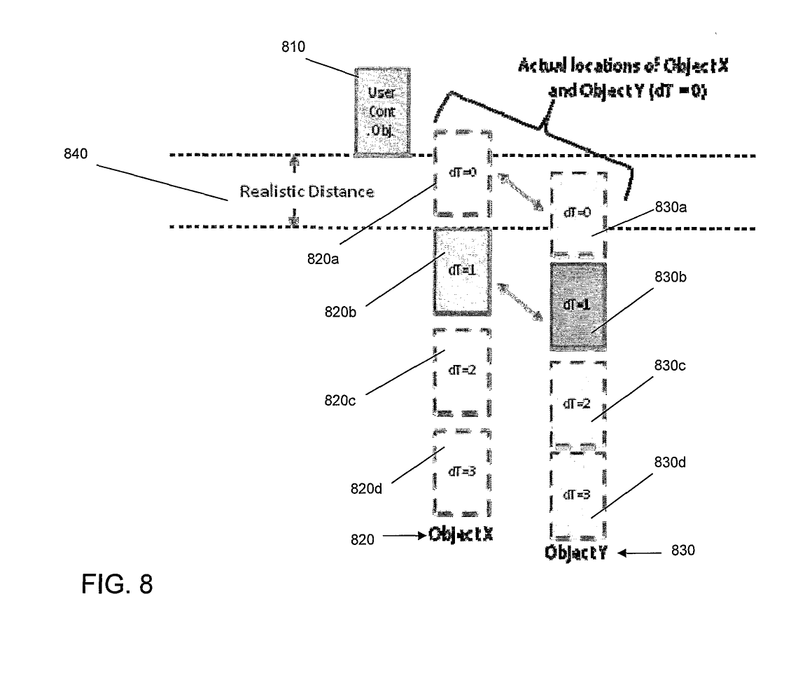

FIG. 8 is another diagram of exemplary objects 810, 820a, and 830a in an exemplary game system and illustrates an overtake of the real-data objects 820a and 830a by an user-controlled object 810. As illustrated, each real-data object 820a and 830a includes a history of one or more previous locations 820 (i.e., 820b, 820c, and 820d) and 830 (i.e., 830b, 830c, and 830d), respectively. The real-data objects 820a and 830a are overtaking the user-controlled object 810. However, since the real-data objects 820a and 830a are within a realistic distance 840 of the user-controlled object 810, the virtual locations of the real-world objects 820a and 830a are at virtual locations 820b and 830b, respectively. In this example, the virtual locations of the real-world objects 820a and 830a correspond in time sequence identification, i.e., time position=1.

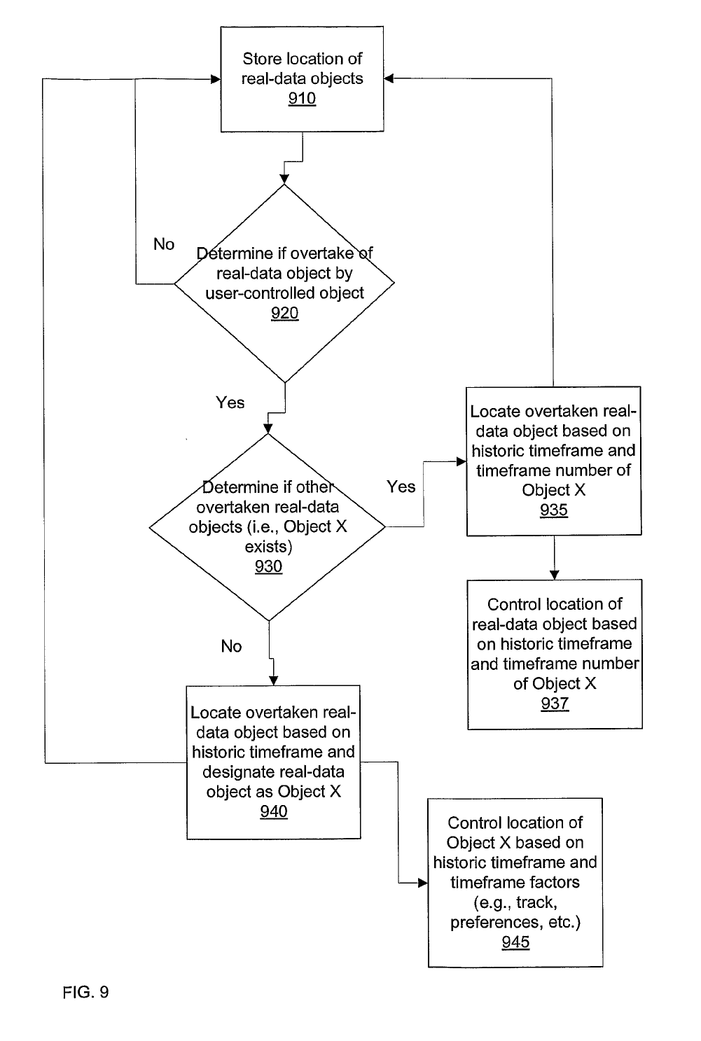

FIG. 9 is another flowchart 900 of exemplary game processing utilizing the game server 330 of FIG. 3. The flowchart 900 illustrates a user-controlled object overtaking a real-data object. The location history module 337 stores (910) locations of real-data objects in the storage device 339 and/or any other type of storage device (e.g., storage area network, etc.). The location control module 334 determines (920) if there is an overtake of the real-data object by the user-controlled object. If there is no overtake, the location history module 337 continues storing (910) locations of real-data objects. If there is an overtake, the location control module 334 determines (930) if there are other overtaken real-data objects.

If there are other overtaken real-data objects, the real-data location module 332 locates (935) the time frame and historic locations of the real-data object based on the overtaken real-data object time frame. The location control module 334 controls (937) the location of the real-data object based on the time frame and the historic location.

If there are not any other overtaken real-data objects, the real-data location module 332 locates (940) the present location based on the historic locations of the real-data object. The location control module 334 controls (945) the location of the real-data object based on the historic locations.

In some examples, the system detects the overtake by analyzing the forward position of the user-controlled object and/or the forward position of the user-controlled object plus the realistic distance (e.g., percentage of length of user-controlled object, set distance, etc.).

In other examples, after the real-data object is overtaken by the user-controlled object, Object Z (the real-data object) becomes Object X. At this point, Object X and Object Y start using information from timeframes out of the history list instead of actual received information. Object X regresses in the history list until Objects X and Y have reached a timeframe with a related location which has a realistic distance behind the user controlled object. From this point, Object X will continuously use historic timeframes (i.e., one or more saved locations) with related information to locate itself on a realistic distance behind the user controlled object. The time information includes the difference of timeframes between the actual timeframe and the active historic timeframe. The difference of timeframes between the actual timeframe and the active historic timeframe is referred to as dT (also referred to as the time position).

In some examples, to keep the positions and relative locations of all real-data objects (i.e., Object Y) behind the user-controlled object, identical all real-data objects located behind Object X will simultaneously regress in their respective history lists with the same amount of timeframes (dT) as Object X. In other words, the dT for all real-time objects behind Object X can continuously be the same. This way all real-data objects behind the user-controlled object can be on the same historic location in time.

In other examples, the realistic distance from the user controlled object can vary depending on the location on the track of the user controlled object, maneuvers of the controlled object and/or just even randomly. The time information (i.e., dT) can be updated accordingly based on the realistic distance.

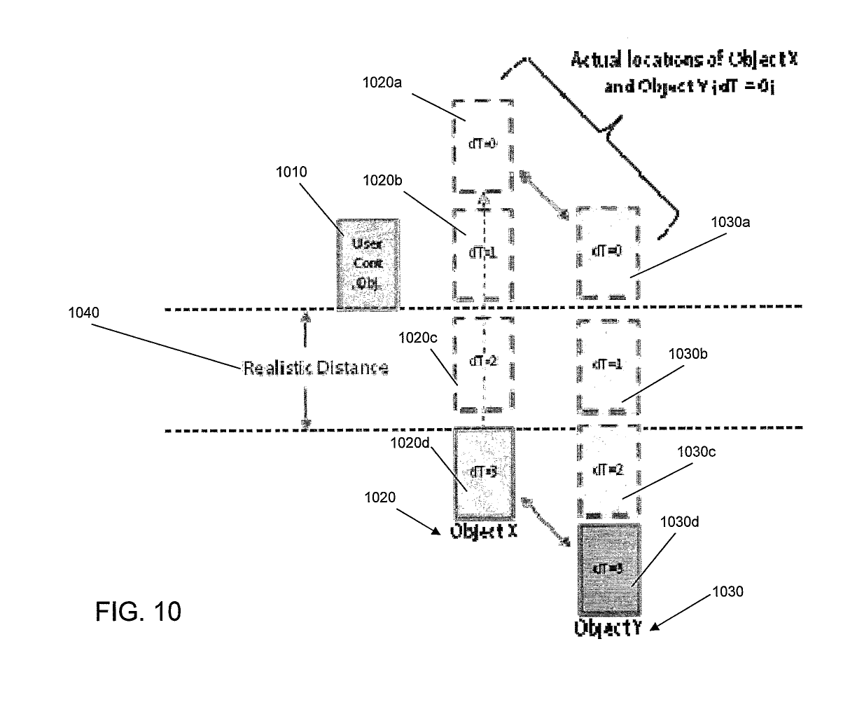

FIG. 10 is a diagram of exemplary objects 1010, 1020a, and 1030a in an exemplary game system and illustrates an overtake of an user-controlled object 1010 by real-data objects 1020a and 1030a. As illustrated, each real-data object 1020a and 1030a includes a history of one or more previous locations 1020 (i.e., 1020b, 1020c, and 1020d) and 1030 (i.e., 1030b, 1030c, and 1030d), respectively. The virtual location of the real-data objects 1020a and 1030a is at the time position=3, 1020d and 1030d, respectively, that is outside of a realistic distance 1040 from the user-controlled object 1010.

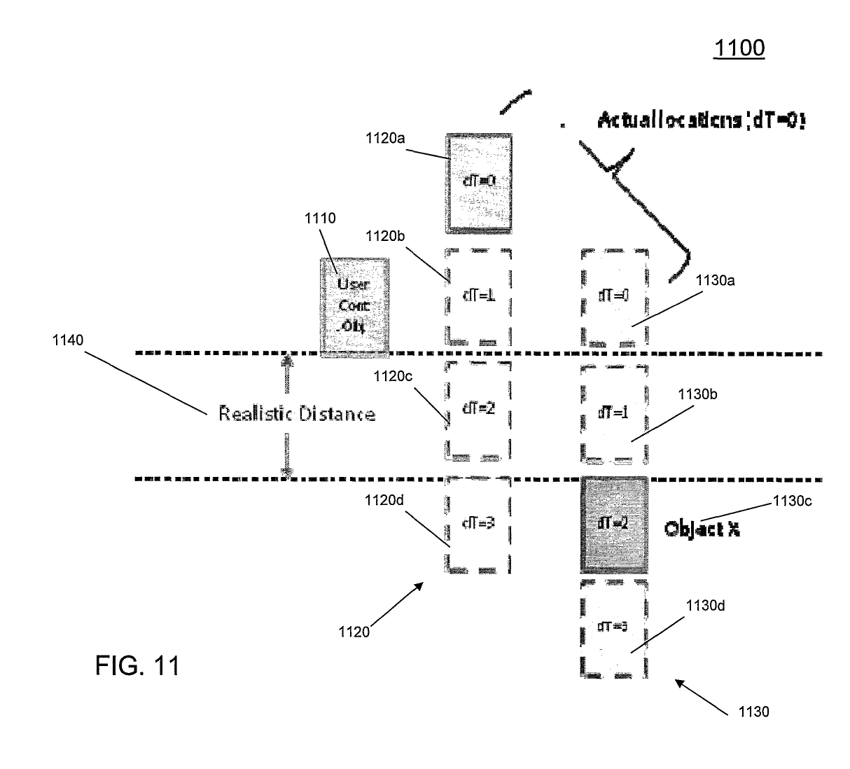

FIG. 11 is another diagram of exemplary objects 1110, 1120a, and 1130a in an exemplary game system and illustrates an overtake of a user-controlled object 1110 by a real-data object 1120a. As illustrated, each real-data object 1120a and 1130a includes a history of one or more previous locations 1120 (i.e., 1120b, 1120c, and 1120d) and 1130 (i.e., 1130b, 1130c, and 1130d), respectively. When the real-world location 1120a of the real-world object 1120a passes the user-controlled object 1110, the virtual location of the real-world object 1120a is moved back to the real-world location 1120a. After the real-world object 1120a returns to the real-world location, the control of the real-world objects reverts to the real-world object 1130c (e.g., control of the time sequence identifier, time position=2). In this regard, the virtual location of the real-world-object 1130a moves to the virtual location 1130c, since this virtual location is the closest to the real-world location 1130a, but still beyond the realistic distance 1140.

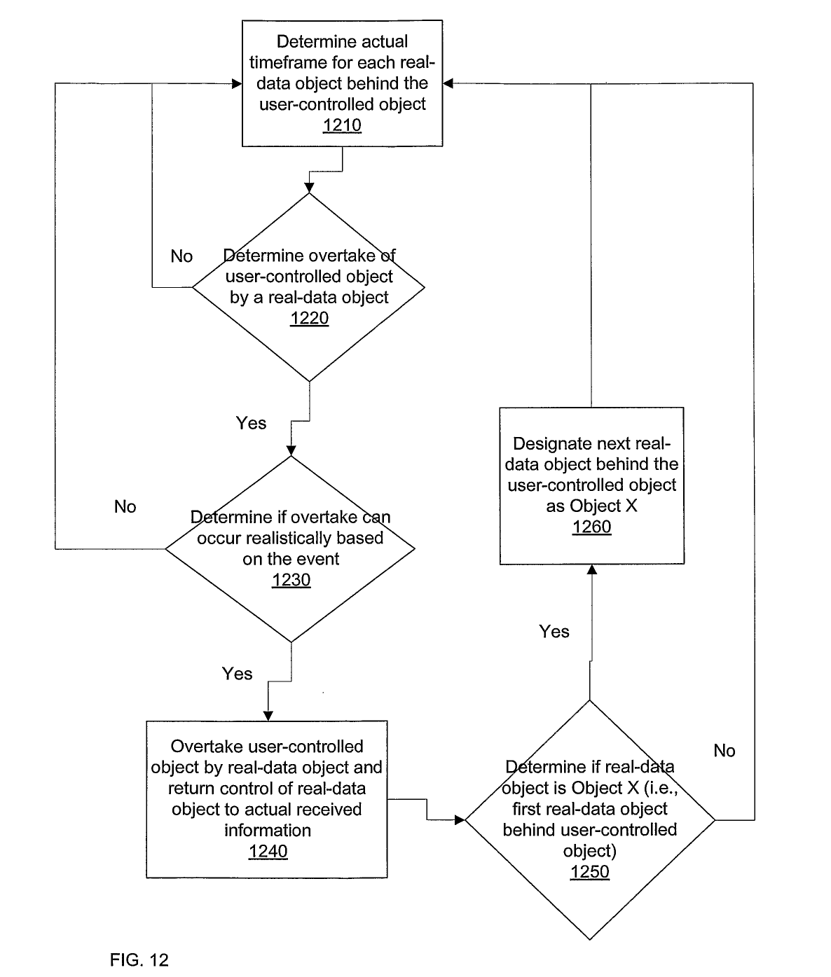

FIG. 12 is another flowchart 1200 of exemplary game processing utilizing, for example, the game server 330 of FIG. 3. The real-data location module 332 determines (1210) the actual timeframe for each real-data object, Object X and Object Y, behind the user-controlled object using historic timeframes to locate the real-data object (dT>0) while continuously checking if the real-data object's location on the actual timeframe is in front of the user-controlled object. The real-data location module 332 determines (1220) if the real-data object overtakes the user-controlled object. If the real-data object does not overtake the user-controlled object, the processing continues (1210).

If the real-data object does overtake the user-controlled object, the location control module 334 determines (1230) if the overtaking can take place in a realistic and achievable manner. If the overtake cannot occur in a realistic and achievable manner, the processing continues (1210). If the overtake can occur in a realistic and achievable manner, the location control module 334 overtakes (1240) the user-controlled object by the real-world object and brings the real-world object back in a realistic way to its actual timeframe and location in front of the user-controlled object.

The real-data location module 332 determines (1250) if the real-data object is Object X (i.e., the first real-data object behind the user-controlled object). If the real-data object is Object X, the real-data location module 332 designates (1260) the next real-data object behind the user-controlled object as Object X. If the real-data object is not Object X, the processing continues (1210). In some examples, all other real-data objects behind the overtaking real-data objects will simultaneously progress in the history list (and related timeframe and location), until one of the real-data objects is first behind the user controlled object and becomes the new object X.

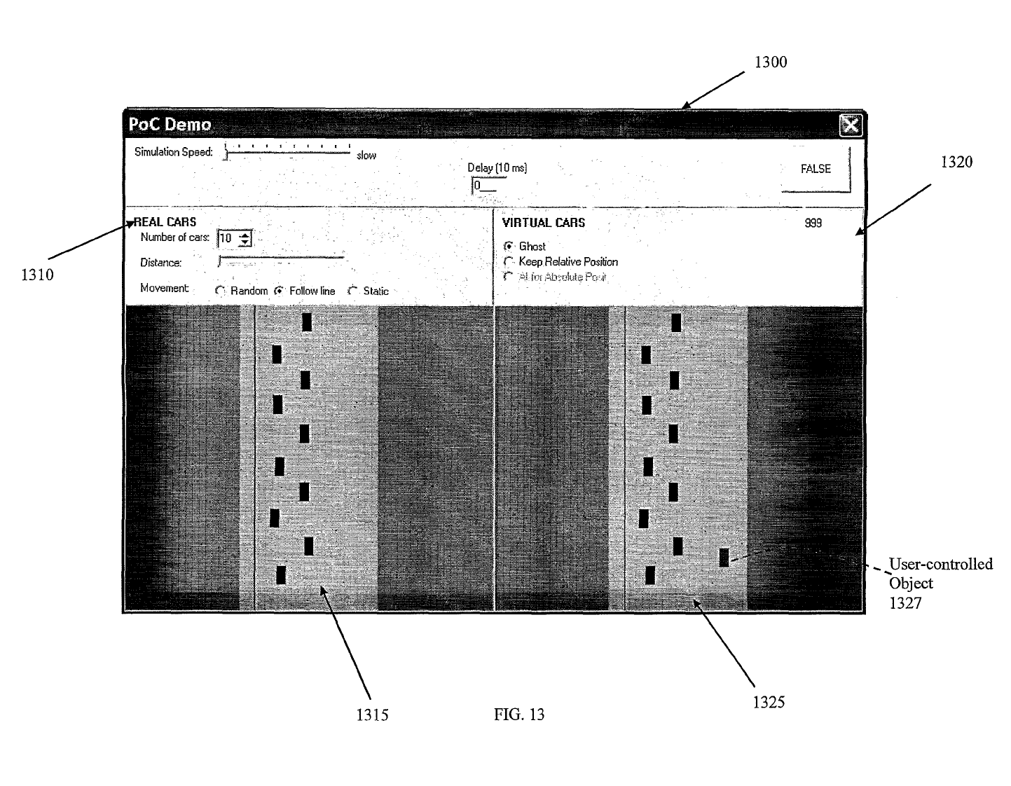

FIG. 13 is a screenshot 1300 of exemplary objects in an another exemplary game system and illustrates a user-controlled object 1327 in a virtual environment 1320 with real-data objects 1325 that correspond with real-data objects 1315 in a real environment 1310.

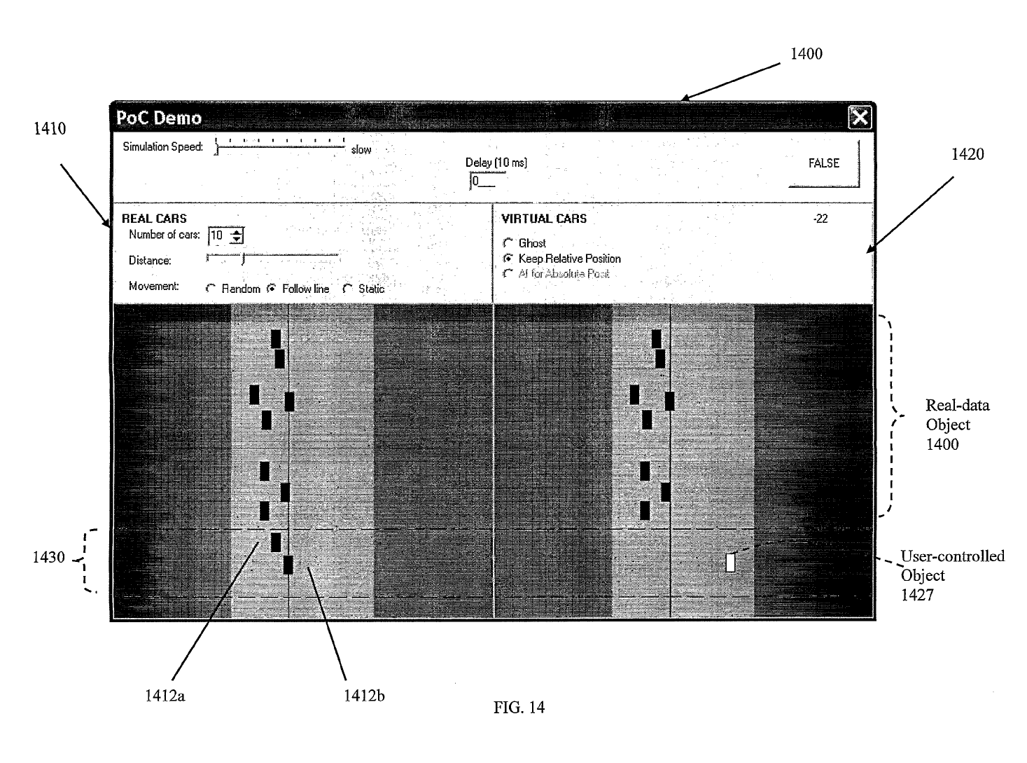

FIG. 14 is another screenshot 1400 of exemplary objects in an another exemplary game system and illustrates a user-controlled object 1427 and real-data objects 1400 in a virtual environment 1420. As illustrated, two real-data objects 1412a and 1412b in a real environment 1410 are within a realistic distance 1430 and are not shown behind the user-controlled object 1427 in the virtual environment 1420.

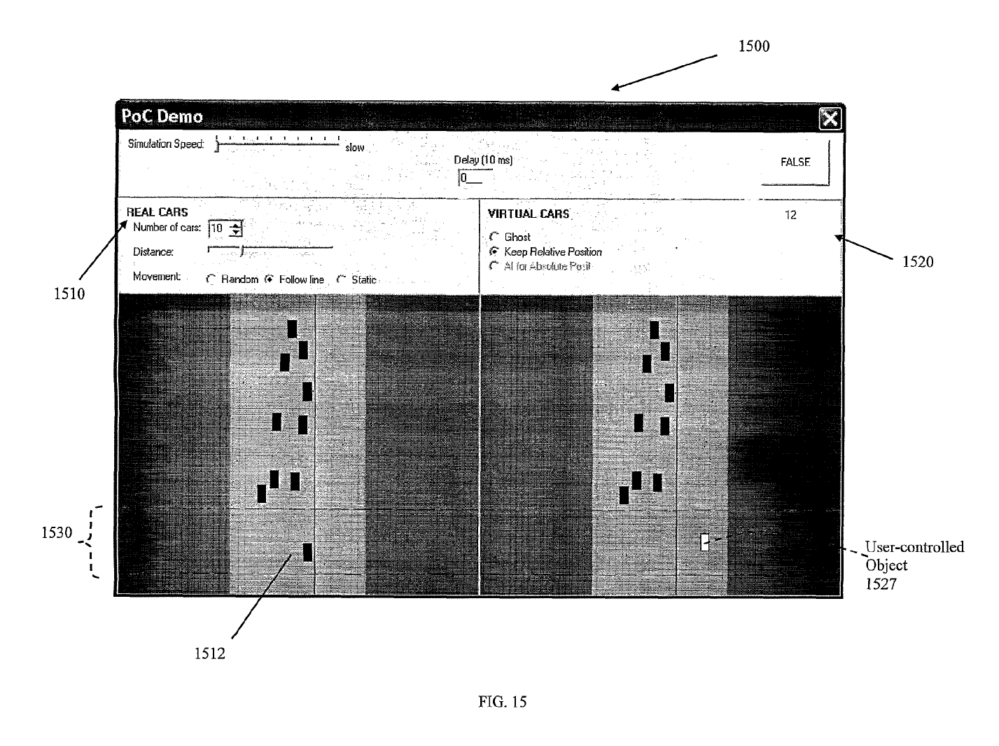

FIG. 15 is another screenshot 1500 of exemplary objects in an another exemplary game system and illustrates a user-controlled object 1527 and real-data objects in a virtual environment 1520. As illustrated, a real-data object 1512 in a real environment 1510 is within a realistic distance 1530 and is not shown behind the user-controlled object 1527 in the virtual environment 1520.

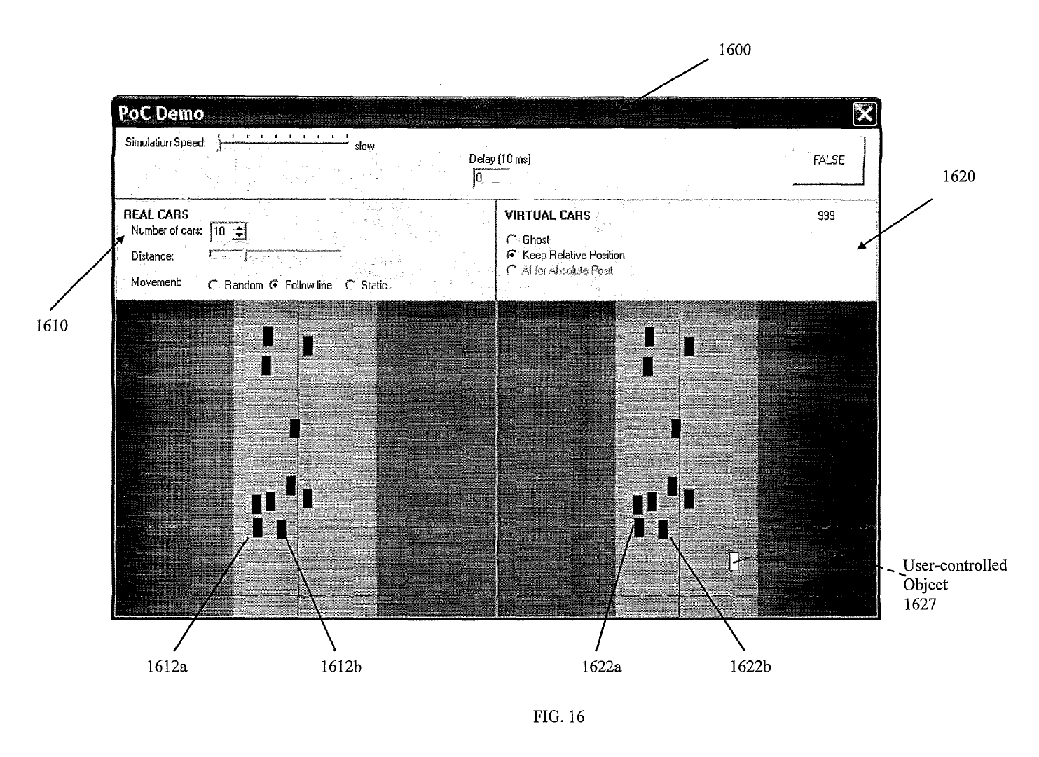

FIG. 16 is another screenshot 1600 of exemplary objects in an another exemplary game system and illustrates a user-controlled object 1627 and real-data objects 1622a and 1622b in a virtual environment 1620. As illustrated, two real-data objects 1612a and 1612b in a real environment 1610 are partially within a realistic distance. However, in this example, the two real-data objects 1622a and 1622b are shown in front of the user-controlled object 1627 in the virtual environment 1620.

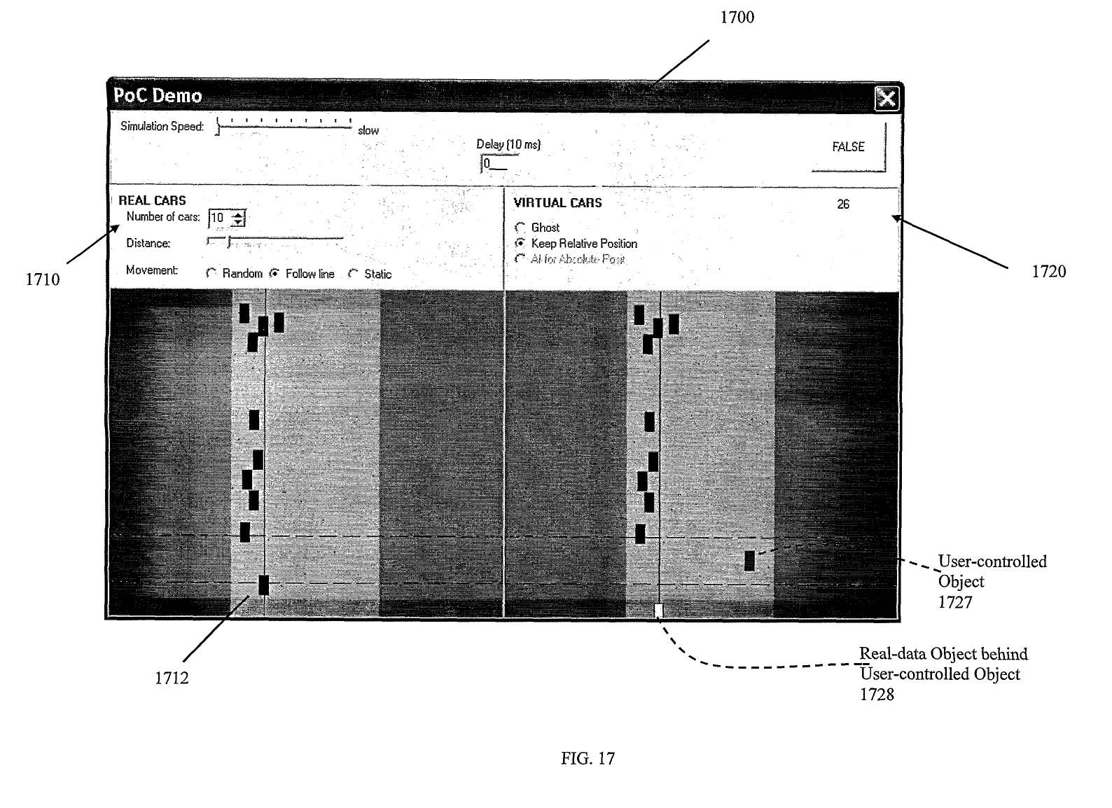

FIG. 17 is another screenshot 1700 of exemplary objects in an another exemplary game system and illustrates a real-data object 1728 behind a user-controlled object 1727 in a virtual environment 1720. As illustrated, the real location of the real-data object 1712 in a real environment 1710 is different from the virtual location of the real-data object 1728 because the virtual location is controlled by the historical list of the real-data object locations.

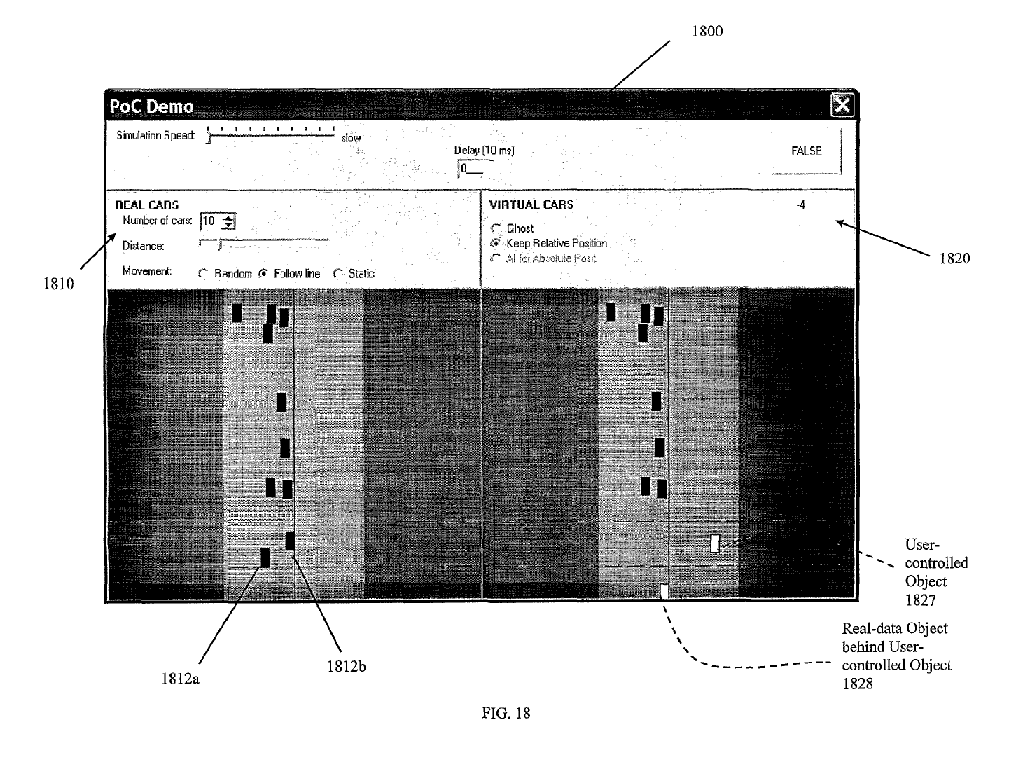

FIG. 18 is another screenshot 1800 of exemplary objects in an another exemplary game system and illustrates a real-data object 1828 behind a user-controlled object 1827 in a virtual environment 1820. As illustrated, the real location of the real-data object 1812b in a real environment 1810 is different from the virtual location of the real-data object 1828 because the virtual location is controlled by the historical list of the real-data object locations. Further, as illustrated, the real-data object 1812a is not within the virtual environment 1820 because the virtual location of the real-data object 1812a is beyond an illustrative distance of the virtual environment 1820 (i.e., outside of the visual range of the user-controlled object 1827.

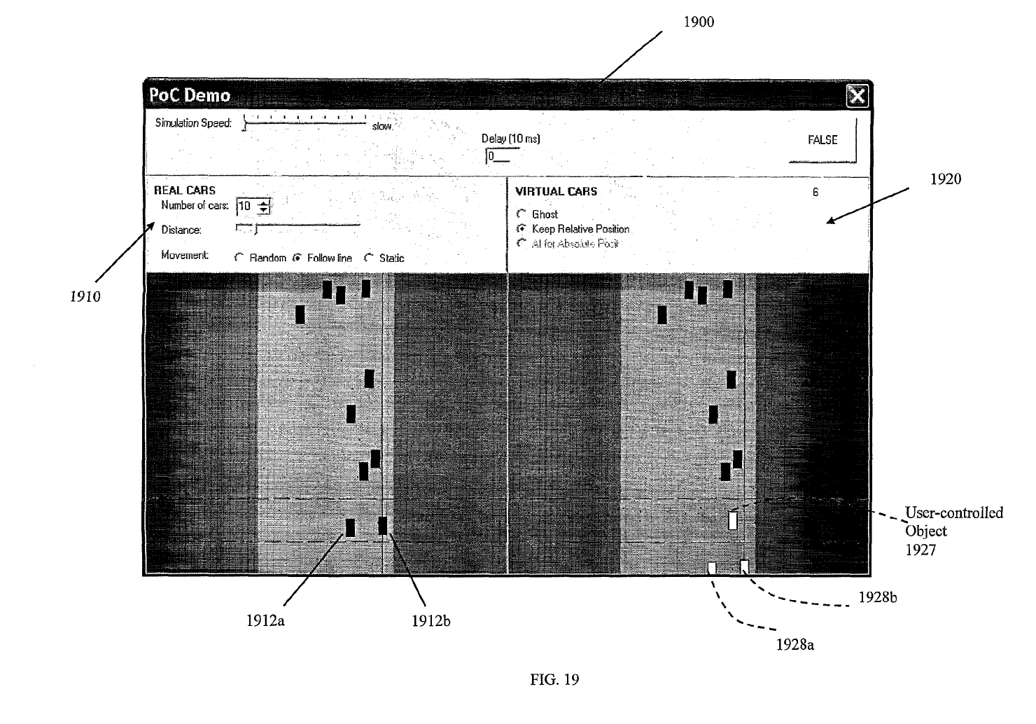

FIG. 19 is another screenshot 1900 of exemplary objects in an another exemplary game system and illustrates two real-data objects 1928a and 1928b behind a user-controlled object 1927 in a virtual environment 1920. The real-data objects 1928a and 1928b follow the user-controlled object 1927 based on the historical list of each, but the timeframe for the location is controlled by a primary real-data object 1928b (i.e., Object X) which controls the timing of which location to utilize. The virtual locations of the real-data objects 1928a and 1928b are different from the real locations of the real-data objects 1912a and 1912b in a real environment 1910, since the real locations are within a realistic distance from the user-controlled object 1927 in the virtual environment 1920.

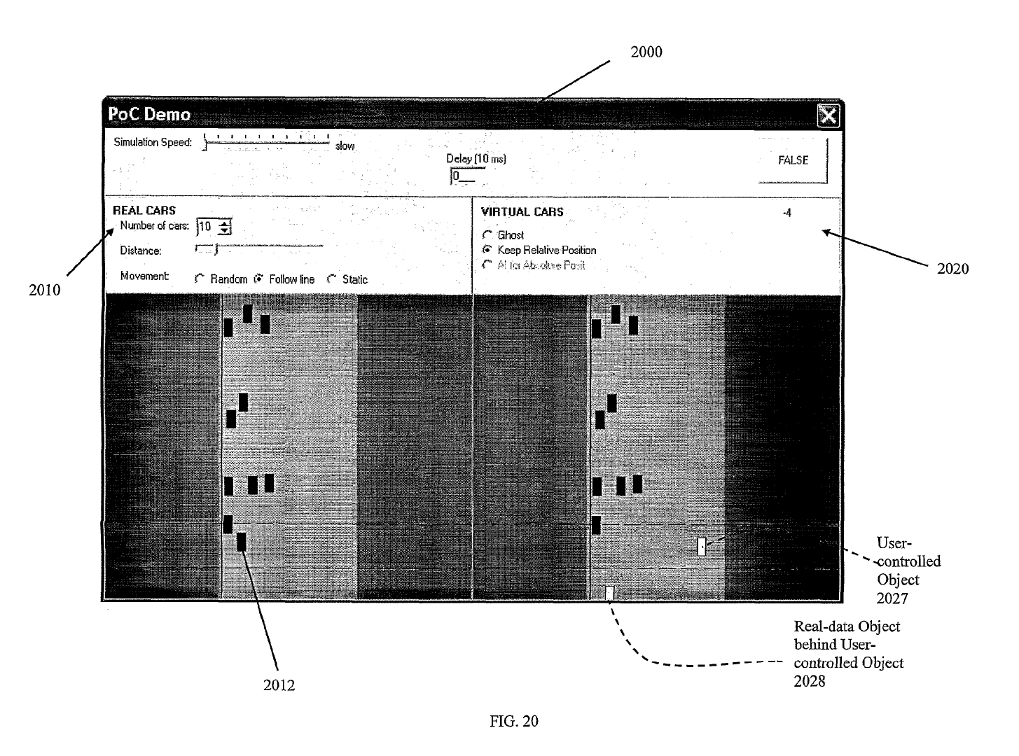

FIG. 20 is another screenshot 2000 of exemplary objects in an another exemplary game system and illustrates a real-data object 2028 behind a user-controlled object 2027 in a virtual environment 2020. The real-data object 2028 follows the user-controlled object 2027 based on the historical list of the real-data object 2028. The virtual location of the real-data object 2028 is different from the real location of the real-data object 2012 in a real environment 2010.

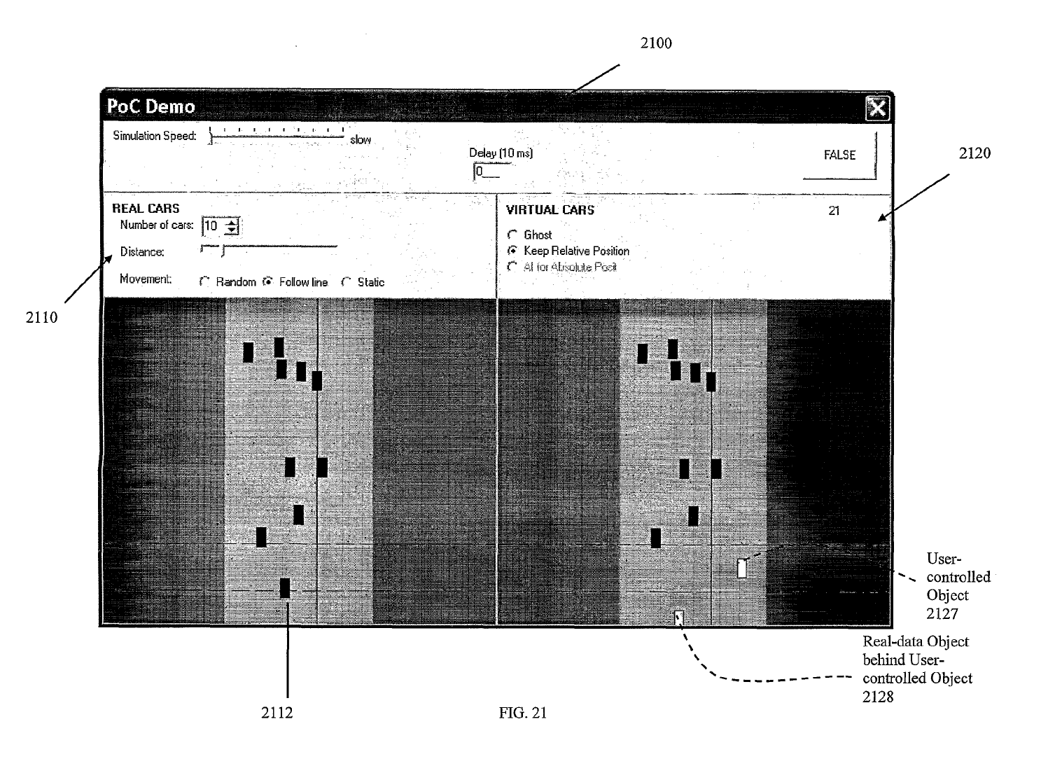

FIG. 21 is another screenshot 2100 of exemplary objects in an another exemplary game system and illustrates a real-data object 2128 behind a user-controlled object 2127 in a virtual environment 2120. The real-data object 2128 follows the user-controlled object 2127 based on the historical list of the real-data object 2128. The virtual location of the real-data object 2128 is different from the real location of the real-data object 2112 in a real environment 2110.

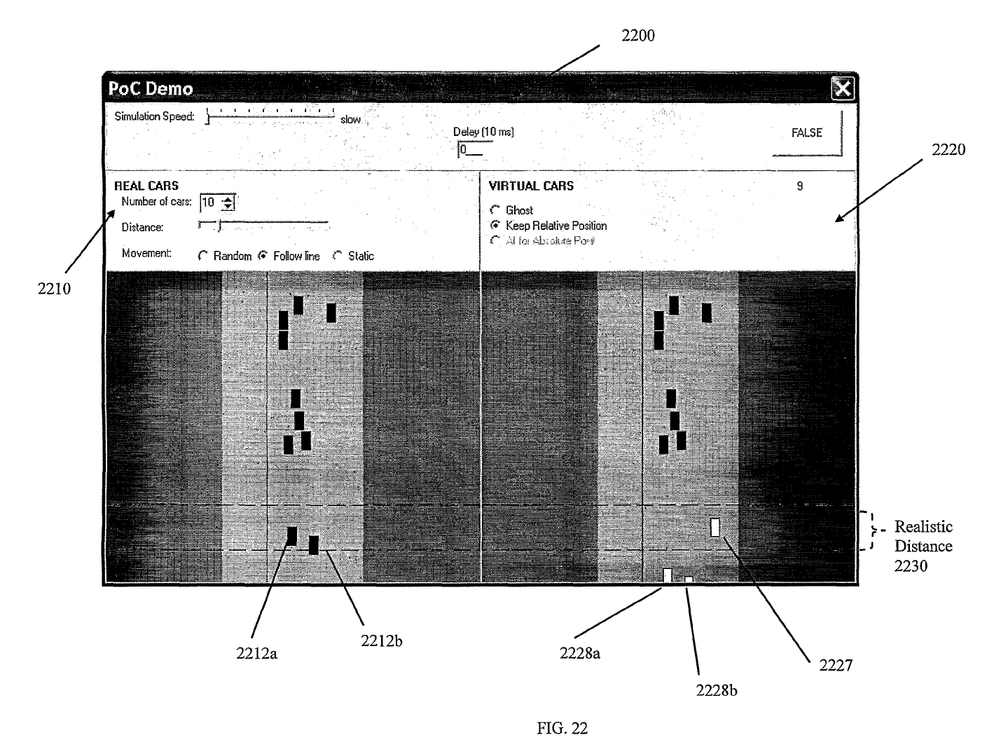

FIG. 22 is another screenshot 2200 of exemplary objects in an another exemplary game system and illustrates a realistic distance 2230 around a user-controlled object 2227 in a virtual environment 2220. The real locations of two real-data objects 2212a and 2212b in a real environment 2210 are within the realistic distance 2230 of the user-controlled object 2227 when placed within the virtual environment 2220. In other words, if the real locations of the two real-data objects 2212a and 2212b corresponded with the virtual locations of the real-data objects, the virtual locations would be within the realistic distance 2230 around the user-controlled object 2227. In this example, the two real-data objects are placed in locations that correspond to the historic timeframes for the real-data objects 2228a and 2228b (e.g., time position=2 behind the current location).

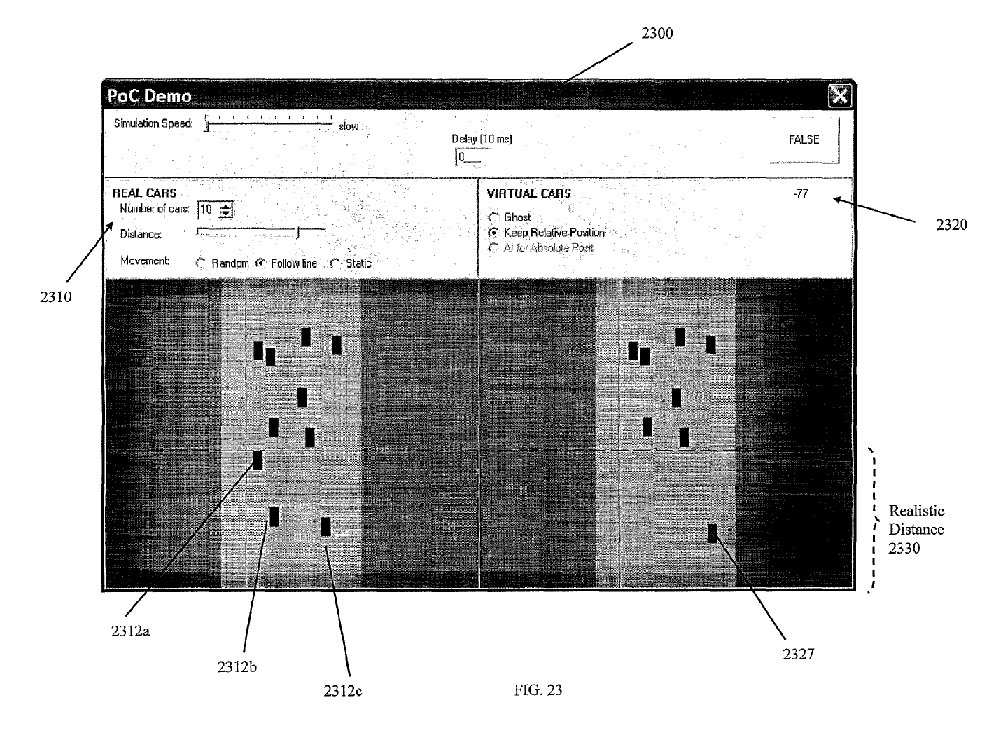

FIG. 23 is another screenshot 2300 of exemplary objects in an another exemplary game system and illustrates a realistic distance 2330 around a user-controlled object 2327 in a virtual environment 2320. The real locations of three real-data objects 2312a, 2312b, and 2312c in a real environment 2310 are within the realistic distance 2330 of the user-controlled object 2327 when placed within the virtual environment 2220. As such, the three real-data objects 2312a, 2312b, and 2312c are not illustrated in the virtual environment 2220, since the virtual locations are outside of the line of sight of the user-controlled object 2327 in the virtual environment 2320.

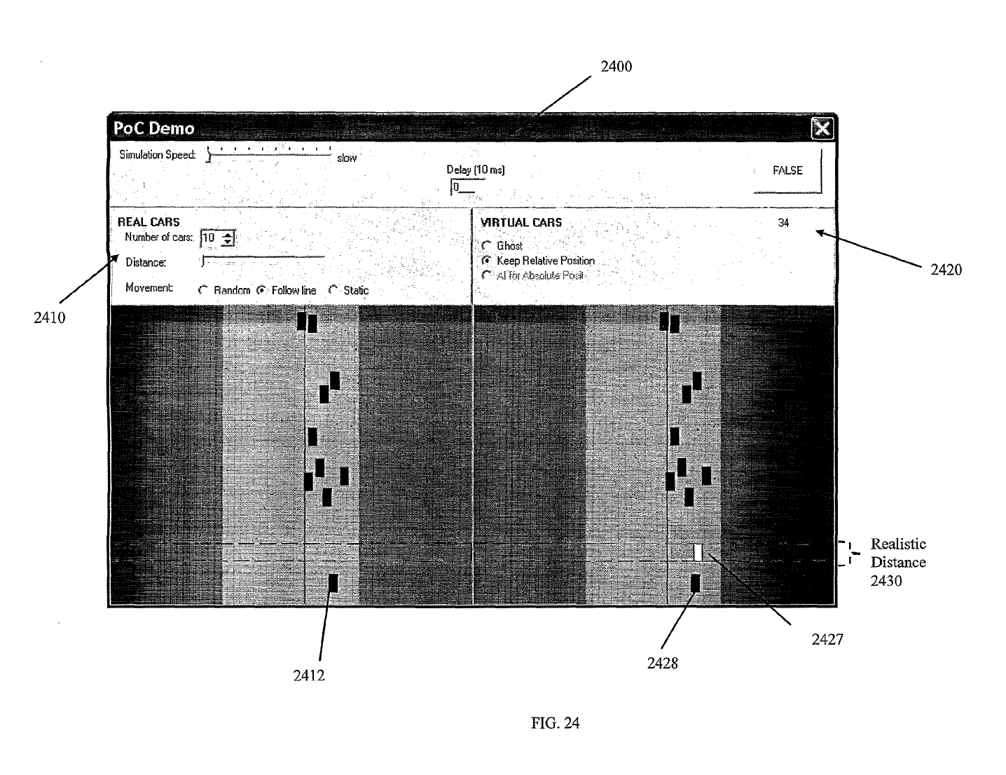

FIG. 24 is another screenshot 2400 of exemplary objects in an another exemplary game system and illustrates a realistic distance 2430 around a user-controlled object 2427 in a virtual environment 2420. The real location of a real-data object 2412 in a real environment 2410 is outside of the realistic distance 2430 of the user-controlled object 2427 when placed within the virtual environment 2410. As such, the real-data object is placed in a virtual location of the real-data object 2428 in the virtual environment 2420 that corresponds with the real location of the real-data object 2412 in the real environment 2410.

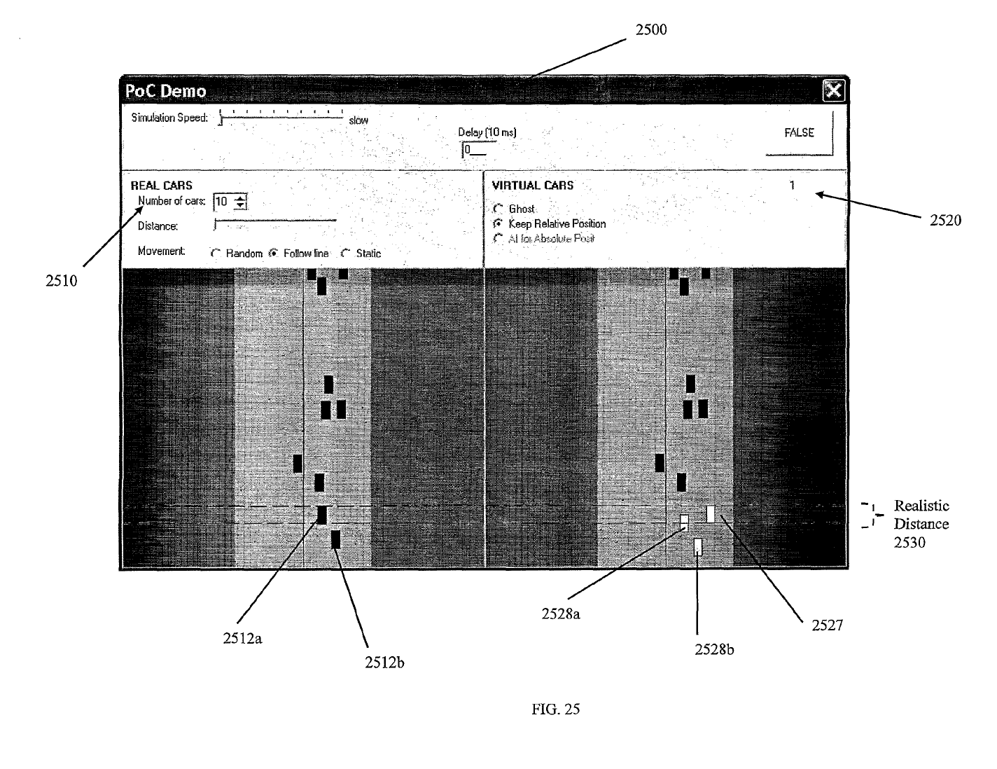

FIG. 25 is another screenshot 2500 of exemplary objects in an another exemplary game system and illustrates a realistic distance 2530 around a user-controlled object 2527 in a virtual environment 2520. As illustrated, the real location of a real-data object 2512a in a real environment 2510 is within the realistic distance 2530. The virtual location of the real-data object 2528a is placed in a virtual location of the real-data object 2528a in the virtual environment 2520 based on a historic timeframe for the real-data object 2528a. Further, since the real location of the real-data object 2512b in the real environment 2510 is behind the real location of the real-data object 2512a, the virtual location of the real-data object 2528b is at a historic timeframe of the real-data object 2528b that correspond to the time position of the virtual location of the real-data object 2528a (e.g., both of the real-data objects 2528a and 2528b are at time position=2).

Table 1 illustrates an exemplary historical list of locations for real-data objects. Although Table 1 illustrates seconds and miles by feet, the list of locations can utilize any type of time measurement (e.g., milliseconds, actual time, etc.) and/or any type of position measurement (e.g., GPS coordinates, longitude/latitude, etc.).

TABLE 1
Historical List of Locations

| | Position (miles from start by feet from left side of track) | | | |
|---|---|---|---|---|
| Time | Real | Real | Real | Real |
| Stamp | Object A | Object B | Object C | Object D |
| 10:32:34 | +1.3 miles by | +1.2 miles by | +0.9 miles by | +1.4 miles by |
| | 12 feet | 1 feet | 5 feet | 10 feet |
| 10:32:35 | +1.2 miles by | +1.1 miles by | +0.8 miles by | +1.1 miles by |
| | 10 feet | 1 feet | 6 feet | 11 feet |
| 10:32:36 | +1.1 miles by | +1.0 miles by | +0.7 miles by | +1.0 miles by |
| | 8 feet | 2 feet | 6 feet | 7 feet |
| 10:32:37 | +0.9 miles by | +0.9 miles by | +0.6 miles by | +0.9 miles by |
| | 11 feet | 4 feet | 5 feet | 9 feet |
| 10:32:38 | +0.8 miles by | +0.7 miles by | +0.5 miles by | +0.8 miles by |
| | 7 feet | 5 feet | 6 feet | 7 feet |

In some examples, dependent on the type of race and/or the allowed tactics, the system can take over the control of a real-data object to let it interact with the user-controlled object. The system can utilize one or more of the following parameters for the interaction:

1. Deviation from reality is as minimal as necessary;

2. No other real-data objects are influenced;

3. Interactions are permitted;

4. Interactions are realistic (e.g. within the limitations of physics, etc.);

5. Interactions are within the expectation of the user/gamer; and/or

6. Interactions enhance the game experience of the user/gamer.

After the interaction, the system can return the real-data objects realistically to their active real-data location.

Above described interactions can also occur in a virtual world where multiple user-controlled objects are present simultaneously. In other words, the control by the system of real-data objects can occur concurrently for a plurality of user-controlled objects.

A virtual world can be a computer-based three dimensional environment with objects, logics, rules, states and/or goals. The virtual world can be, graphically represented, a simulated representation of a real world environment, and/or a computer game.

In some examples, information about the position, direction, and state of objects is needed to represent an object in the virtual world. This information comes from a data source. The data source can be one or more of the following: i) computer input means like keyboard, mouse, joystick, wheel, game pad, etc.; ii) another computer or a computer network; iii) a real world object which is monitored; iv) a stored data file; v) streamed data over a network; vi) a set of algorithms which generates the representation information; and/or vii) any other type of data source (e.g., database, externally generated data, internally generated data, etc.). However, it should be understood that this list is not all inclusive.

In other examples, the data source can provide the information in real-time and/or delayed. If multiple objects in the virtual world become their representation information from different data sources that are not aware of each other, their representation in the virtual world can result in an unrealistic presentation of the virtual world (i.e., the presentation does not match with the objects, logics, rules, states and/or goals of the virtual world).

In some examples, a real-world object (RWO) is a moving object that (1) exists in the real world, (2) has some associated steering intelligence, and/or (3) is represented by an avatar within a virtual environment (world). Depending on the context, the RWO references both the object in the real world and its avatar in the virtual world. In a racing game, for example, this is any tracked real-world racing car (driver included).

In other examples, a virtual object (VO) is a moving object that (1) exists only in the virtual environment, without any real-world equivalent, and/or (2) has some associated steering intelligence. The virtual object can be user-controlled and/or controlled by artificial intelligence. In the racing game, for example, this is the racing car controlled by the player.

In some examples, the artificial intelligence (AI) module is part of the system. The AI module can alter the information (e.g., information from the data source) for an object in such a way that a representation of an object in the virtual world does match with the objects, logics, rules, states and/or goals of the virtual world. The AI module can further simulate awareness of the presence of other objects which are also present in the virtual world.

The AI module can advantageously keep the distortion from the “not intervened situation” as small as possible so that the virtual world is as close to the real world as possible. The AI module can advantageously, gradually, and realistically return the real-world object to the “not intervened” situation.

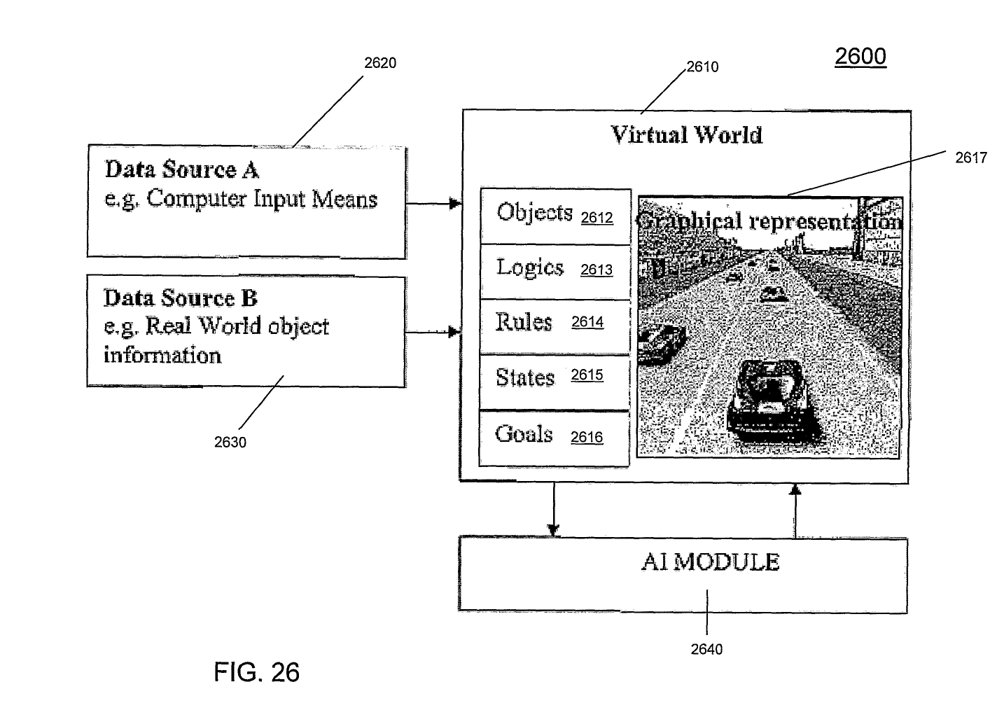

FIG. 26 is a diagram of another exemplary game system 2600 and illustrates a race game (i.e., virtual world) with two cars (i.e., objects)). The system 2600 includes a virtual world 2610, a data source A 2620 corresponding to a user-controlled object, and a data source B 2630 corresponding to a real-world object. The virtual world 2610 receives data from the data sources A 2620 and B 2630. The virtual world 2610 communicates with an AI module 2640 to simulate the real-world event in the virtual world (e.g., determine intersections between objects, determine alternative paths, etc.). The virtual world 2610 includes objects 2612 (e.g., real-world object, user-controlled object, etc.), logics 2613 (e.g., two objects cannot occupy the same space, etc.), rules 2614 (e.g., speed, physics, etc.), states 2615 (e.g., race, flag, etc.), and goals 2616 (e.g., finish line, exit, etc.). For example, one car is controlled by the user (i.e., data source A) and the other car is controlled by telemetry data from a real car received over the internet (i.e., data source B).

As an additional example, both cars are represented in the game. The user controlled car A is a few meters in front of the telemetry car B. Both cars are governed by the rules of the race game and are represented to conform to the data received from their corresponding data sources.

As a further example, the user hits the brake and car A starts slowing down. The AI module 2640 determines that a collision between car A and car B can occur. In some embodiments, collisions are not a desired goal of the race game based on the logic, rules, and/or goals of the virtual environment. As such, the AI module 2640 alters the data for the involved objects. As such, the course and speed of car B is changed so that a collision is prevented.

As an additional example, when the risk of a collision according to the actual data is minimal based on the logic, rules, and/or goals, the AI module 2640 gradually changes course and speed of car B so that car B can quickly, but realistically return to its actual position, course, and speed.

The AI module 2640 can, for example, operate in the virtual environment 2610 for prediction and interpolation management and/or for overlap avoidance. The AI module 2640 advantageously predicts when two moving objects are in risk of imminent collision. The AI module 2640 can continuously monitor the virtual environment 2610 and determine where the objects may go, given the parameters of the current situation. Via this monitoring and determination, the AI module 2640 can determine whether or not evasive maneuvers are needed.

In some examples, prediction is important when the data stream received from the real-world object is interrupted. In other words, the avatar still needs to behave realistically and the AI module 2640 needs to predict the position of the real-world object based on its current position and previous known positions (i.e., historical information). Table 2 illustrates the real-world data points and the predicted data points.

TABLE 2

| Time in Seconds | Real-World Location | Predicted Location |
|---|---|---|
| 0 | 1.3 miles | — |
| 1 | 1.5 miles | — |
| 2 | 1.7 miles | — |
| 3 | 2.1 miles | |
| 4 | No Data | 2.5 miles |
| 5 | No Data | 2.9 miles |
| 6 | No Data | 3.3 miles |

The AI module 2640 can advantageously predict intervening data points between actual data points. In other words, if the AI module 2640 only receives data points from the real-world object every three seconds, the AI module 2640 can interpolate the data points for the real-world object in the time in between. Table 3 illustrates the real-world data points and the interpolated data points.

TABLE 3

| Time in Seconds | Real-World Location | Interpolated Location |
|---|---|---|
| 0 | 1.3 miles | — |
| 1 | 1.4 miles | — |
| 2 | — | 1.5 miles |
| 3 | 1.6 miles | — |
| 4 | 1.7 miles | — |
| 5 | — | 1.8 miles |
| 6 | 1.9 miles | — |

The AI module 2640 can, for example, operate to avoid overlap between any objects at all times (e.g., objects may touch each other, but never occupy the same space). In the virtual environment 2610, the assumption is that the real-world objects exist simultaneously in the real world, and consequently never occupy the same space. Therefore, in general, only the relative positions of virtual objects against real-world objects have to be tested (except when the position of an real-world object has been already altered to avoid overlap).

If a virtual object and a real-world object are close together (e.g., positions are not realistic, collision is imminent, etc.), the AI module 2640 can, for example, take action to maintain realism. For example, if two cars in the race game are very close together, a real driver would initiate evasive maneuvers to prevent himself from crashing into another car.

The AI module 2640 advantageously operates to maintain goals 2616 for the virtual environment. The goals 2616 can include believability, realism, real-time, and/or stability of the virtual environment.

The AI module 2640 can operate to maintain the illusion of believability for the users. Even if it is impossible to accurately model the actual situation because of the influence the virtual objects have on the current situation, the illusion should always be good enough for the player to be able to believe that it is completely realistic. For example, if a solution to the problem of overlap is implemented by just staying behind other cars, then suddenly jump to a position in front of them if the real-world object is there, the user will notice and the game experience will suffer.

The AI module 2640 can operate to maintain the illusion of realism. The realism is generally a little stricter and a little less pragmatic than believability. As an example of the difference between realism and believability when we would need a speed that is just a little bit over the actual maximum speed to get back to a correct situation: realism would not allow for this, but given the fact that it is very improbable that any user would ever notice the difference, believability would. As such, the AI module 2640 can prioritize the goals of the virtual environment to ensure the optimally balanced user experience.

The AI module 2640 can operate the virtual environment in real-time and/or based on stored information. The AI module 2640 can operate in real-time, with a short delay, and/or based on stored information. The AI module 2640 can operate based on stored information to provide a pay-per-view service after the actual real world event occurs. In other words, the AI module 2640 can replay a race event many times based on the stored information. The AI module 2640 can further calculate solutions (e.g., passing method, overtake method, etc.) in real-time (e.g., in reference to the actual real-world event, in reference to the timeframe of the stored event, etc.), given only data that is currently available. The AI module 2640 can compute the next state before it is actually displayed to the user.

The AI module 2640 can operate a stable virtual environment. The stable virtual environment includes the termination of any changes from the data source in a reasonable time and/or limiting the overlap between displaced real-world objects. For example, as soon as any real-world object is displaced to prevent overlap with a virtual object from occurring, the real-world object may overlap with another real-world object in the virtual environment. In this way, the displacing of real-world objects can become unstable, with each displacement triggering another, and so on. The AI module 2640 operates to ensure that this chain of displacements terminates, and preferably without displacing unnecessarily many real-world objects. As such, the AI module 2640 operates to make the virtual environment represent reality as close as possible.

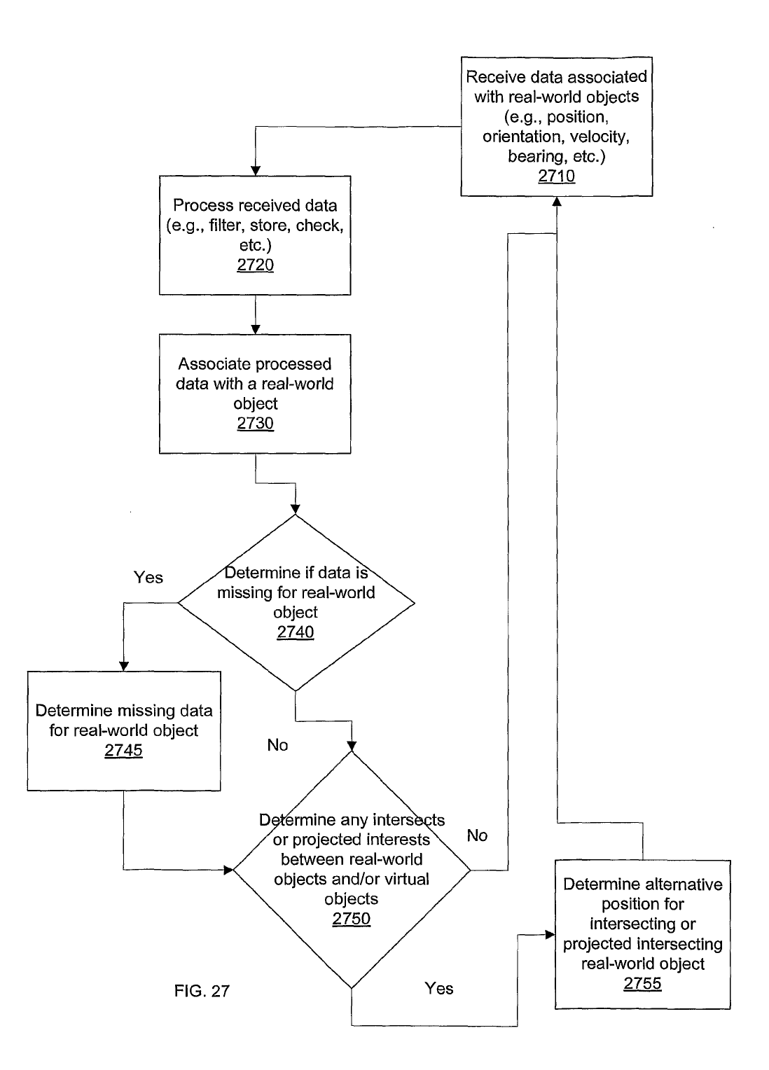

FIG. 27 is another flowchart 2700 of exemplary game processing utilizing, for example, the AI module 2640 of FIG. 26. The AI module 2640 receives (2710) data associated with real-world objects. The AI module 2640 processes (2720) the received data and associated (2730) the processed data with a real-world object. The AI module 2640 determines (2740) if data is missing for a real-world object (i.e., not available). If data is not available for a real-world object, the AI module 2640 determines (2745) the missing data (e.g., interpolation). If the data is available, the AI module 2640 determines (2750) if there are any intersects or projected intersects between real-world objects and/or user-controlled objects. If there are no intersects or projected intersects, the processing continues (2710). If there are intersects or projected intersects, the AI module 2640 determines (2755) an alternative position for the intersecting or projected intersecting real-world object.

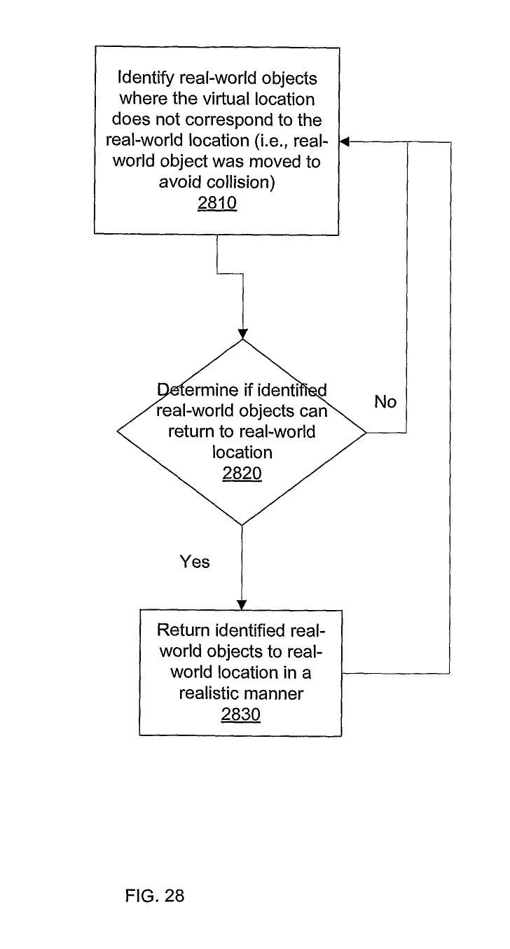

FIG. 28 is another flowchart 2800 of exemplary game processing utilizing, for example, the AI module 2640 of FIG. 26. The AI module 2640 identifies (2810) real-world objects where the virtual location in the virtual environment does not correspond to the real-world location of the real-world object. The AI module 2640 determines (2820) if the identified real-world objects can return to their real-world locations. If the identified real-world objects cannot return to their real-world locations, the processing continues (2810). If the identified real-world objects can return to their real-world locations, the AI module 2640 returns (2830) the real-world objects to their real-world locations in a realistic manner (e.g., speed constraints, location constraints, etc.).

In some examples, the AI module 2640 can operate to predict collisions, interpolate data points, and/or avoid overlaps.

In some examples, the system allows a user-controlled object to compete in a race and/or any other type of event against objects which are controlled by real-world information. The information is presented to the user in such a way that the user perceives that he/she is really taking part in that race. The user-controlled object can be presented in a field of real-data objects while keeping the relative locations of the real-data objects in front and/or behind the user-controlled object, as in the real world.

Interactions between the real-data objects and the user-controlled object can be, for example, managed by a client utilizing an artificial intelligence (AI) engine (also referred to as an AI module). The AI engine includes, for example, a collision detection module to manage (i.e., prevent) collisions of the virtual-race car with the real-world cars (also referred to as GPS managed cars). Although the interactions between the real-data objects and the user-controlled object is described as a racing event, the interactions can occur in any type of event that can include real-world objects and virtual objects (e.g., track, football, dancing, etc.).

In some examples, the interactions between real-world objects and virtual objects are managed utilizing polygon tunnels projected from the virtual car according to a speed and/or a bearing of the virtual car. When an end user positions the virtual car in close proximity to one of the GPS managed cars, one of the polygon tunnels intersects with the GPS managed car, identifying a potential collision between the two vehicles.

In other examples, the interactions between real-world objects and virtual objects are managed utilizing a realistic distance field (e.g., dynamically generated distance, pre-determined distance, etc.) and/or the history of the real-data objects. When an end user positions the virtual car in close proximity to one of the GPS managed cars, the GPS managed car enters into the realistic distance field of the virtual car, identifying a potential collision between the vehicles.

For example, upon the detection of a collision, the AI engine temporarily takes over control of the GPS managed car, operating it in an autonomous mode. The AI engine can initiate an overtake sequence determining whether it is wise to overtake the virtual car at the particular point on the track, and whether the overtake of the virtual car can be accomplished at a sensible speed given the position on the track. If the AI engine decides to have the autonomous car overtake the virtual car, the AI engine performs an overtake sequence, overtaking the virtual car, and recalculating its position on a frame-by-frame sequence. When the autonomous car completes the overtake procedure, the car is repositioned to the actual position of the GPS managed car. The repositioning takes place at a time over a series of frames to provide a smooth and realistic transition. Once the autonomous car reaches the position of the GPS managed car, the car is once again managed by GPS data from the real-world car.

In some examples, the AI engine determines an overtake of a virtual object by a real-world object. For example, in the race-game example, the overtake problem occurs when a real-world car is behind a virtual car, and the real-world car is driving faster than the virtual car. In this example, the real-world car has to drive through the virtual car—which is, of course, not realistic. In this example, control over the real-world car is temporarily taken over by the AI engine. The AI engine can have several, interrelated goals now: the car should start where it currently is, should overtake the virtual car in a plausible way, should get back on track after overtaking, and, most specifically, should get back to a data point at the exact time the real-world object was there—and must evade all other real-world objects and virtual objects in the mean time. To do this, the system can take the following steps: (i) Calculate the current distance between the projection of the virtual car onto the actual path, and the real-world car; (ii) Develop an offset=f (dist) function that is centered around 0. The shape of the curve should be fit for the application itself—examples of different factors include relative speed, relative size of the real-world object and virtual object, and maneuverability. Also, the offset function should return 0 with the starting distance as a parameter (since no offset is used at the time the displacement starts). As a last demand, the function should ensure that the objects don't hit each other, not even with small corners. (iii) At each time-step, the system calculates the distance along the actual path between the real-world car's actual position and use this distance as the input for the offset function. The result off this offset function is the distance by which the car should be displaced, perpendicular to the local tangent of the actual path. The offset should be applied in the most logical direction: if the obstructing virtual car is to the left of the actual path, the offset should move the real-world car to the right.

Described herein are examples of the interactions between the user controlled objects and real-data objects. In these examples, the user controlled object, the real-data object, and object X are utilized as described below. The user controlled object is an object in a virtual world, where location and other properties are controlled by a user (e.g., gamer, referee, etc.). The real-data object is an object in a virtual world, where location and other properties are acquired from a real object in the real world. For each real-data object, at least location information for each timeframe is stored in a history list. Also, other information from the real-data object, for that timeframe, can be stored (e.g., speed, heading, orientation, etc.). Object X is the first real-data object behind the user controlled object.

In some examples, the system ensures that real-world objects remain true to their actual positions whenever possible, while also taking into account the virtual object. In particular, the system can ensure that the representations of real-world objects (also referred to as real-data objects) take into account the virtual object (also referred to as user-controlled object) and react appropriately.

In other examples, real-world objects that are not fixed, are referred to as dynamic objects, whereas those that are fixed are referred to as static objects. Information captured by the system allows the system to determine, for example, where the dynamic objects are, what they are doing, and/or what they represent.

In some examples, the system gathers and distributes detailed information about the position of the real-world dynamic objects during the course of the event (e.g., actual position, relative position, etc.). The system can also gather state information from the event (e.g., flags, signs, weather, etc.).

In other examples, the system includes a position locating means for continuously determining real-world positions of the dynamic objects during the event in relation to static objects within the environment. The position locating means can include, for example, one or more position sensors which provide real-time updated positions of the dynamic objects during the course of the event. As an example, each dynamic object can include a respective position sensor, such as a Global Positioning System (GPS) receiver. The GPS receiver can recalculate its position at a rate of up to 50 Hz. The system can interpolate between successive inputs, if necessary (e.g., if an end-user display refresh rate is different than a position update rate).

In some examples, the dynamic object can also include additional sensors sensing other information related to the dynamic object (e.g., RPM, speed, throttle position, gear position, inertial measurement units (IMU) detecting the current rate of acceleration and changes in rotational attributes, including pitch, roll and yaw, etc.). In other examples, speed information can be derived from position and not obtained directly from a speed sensor, such as a speedometer on the real world object.

In some examples, the system includes features for enhancing positional resolution obtained by the GPS receiver to about +/−10 cm, preferably approaching 1 cm horizontal and 2 cm elevation. Such enhancement features include, for example, Differential GPS (DGPS), Carrier-Phase enhancement GPS (CPGPS), Omnistar correction message, ground based reference stations, Novatel Waypoint software, and/or combinations with IMU. The system can also include one or more sensors which gather information from static objects and/or event states (e.g., flags, signs, weather, etc.).

In some examples, some of the event information, such as weather, flags, signs, etc., can be gathered (e.g., manually, automatically with sensors, etc.) and fed into the networked server.

In other examples, the networked server has access to storage (e.g., database) and/or includes an administrative terminal. All systems connected to the Internet can include a firewall and/or other security measures for protection and privacy.

In some examples, end-user game stations receive data from the media caster through the Internet and/or any other type of communication network. The end-user game stations may include personal computers (e.g., mobile phones, other handheld communication device, transmitting device, etc.) and/or a game console (e.g., XBOX game console, PS3 game console, etc.). Although the GPS positional solutions can include GPS time values, timing within the virtual representation does not have to be, for example, synchronized to any GPS timing information.

Referring back to FIG. 1, the networked server receives all of the raw information from the dynamic objects and the local environment. At least some of this information comes to the networked server by way of the communication solution, which can include a radio base station and/or any other type of transceiver. The networked server stores this data in the database, also filtering, optimizing, and/or repairing the data, as required. For example, the networked server performs a cyclical redundancy check (CRC) and checks for telecommunication outages. The networked server stores the data in suitable format for further processing (e.g., by media casters).

In some examples, media casters are servers connected to the Internet and are configured to retrieve event data from storage and to send the data in a continues stream to the end-user game stations, referred to generally as game clients, which are under the control of end-users (i.e., players). The data can include position data, telemetry data when available, and more generally, any data obtained or derived from the physical event.

In other examples, multiple media casters can be located in a geographically dispersed arrangement (e.g., worldwide) to provide an optimal connection to the game clients. The client may retrieve streaming data from a local media center. The data stream to the game client can optionally be protected with encryption.

In some examples, the system can include one or more services, such as a receiving service, a database service, a filtering and optimizing service, and/or a game server. The receiving service application runs in the background to receive the raw data and store it in a database. The database service can be a standard off the shelf database application configured for high volume data transactions. Several databases can be created to store information relating to the dynamic objects (e.g., cars), the environment (e.g., a track), and other information. The filtering and optimizing service is an application that checks the data stored in the database, filters it from strange values, calculates, optimizes and adds missing values (i.e., data outage) in the database.

The game server is an application that makes it possible for game clients to connect to the media casters. The game server sends instructions to a database controller to select which data from the database will be delivered (real-time or historic races). The game server also gathers the selected data from the database and sends them as data packets to the connected game clients. Although FIG. 1 illustrates the game server separate from the other services, the game server can be integrated into these other services, multiple game servers can be operating within the system, and/or the game server can be integrated into any other part of the system.

In other examples, the system includes features to handle minor data outages. For example, the system uses Kalman filtering to filter and eventually predict minor data outages as may be experienced due to lost or corrupted data packages. The System also counts the number of missing packages and predicts the values of the missing packages. For major data outages, for which the Kalman filter no longer reliably predicts where the dynamic object may be (e.g., 1-2 seconds or more), the networked server sends a signal to the client. During the outage, the client manages the dynamic object in an autonomous mode, as described in more detail below. In some instances, a delay is provided and maintained between the time streaming data is received and the time such data is played back or used.

In some examples, the system includes features to allow a user to pause, rewind, and/or fast forward the event. The pause, rewind, and/or fast forward features can be utilized in a recorded playback of the event and/or in live playback of the event. For example, the user can be simulating a race car in a live race and need a break. In this example, the user can pause the simulation and the resume the simulation after the break. The user can, for example, continue at the paused location after the break and then play in a recorded playback simulation and/or the user can fast-forward the race to the live simulation (e.g., reposition the simulated car based on its past performance, jump to a pit-stop, etc.).

In other examples, the system includes one or more client applications, attached to the networked server through a network, such as the Internet, in a client-server configuration. Input to the client application is a stream of data from the networked server. The exact format of the data can be defined, such as: Message ID; Car ID; General Unit Status; GPS signal; etc. The client applications feature demonstrates in a graphical manner that real-time (or close to real-time) data can be interpreted and visualized in a virtual world. The application also demonstrates areas in which the end-user (i.e., game participant) can interact with the virtual world.

In other examples, the client includes an initialization capability. This capability can include initializing dynamic and virtual objects within the virtual representation, initializing the graphic engine, opening a log file, and/or configuring user controls (e.g., mouse, keyboard, gamepads, steering wheel, etc.). The user controls allow an end user (i.e., player) to control a virtual object injected into the virtual representation of the physical event. The initialization capability also handles configuration settings, such as selectable user-perspective views of the virtual event (e.g., top-down, top-down with active car centered in view, and view behind car). The client also reads a collection of points describing the static objects in the real-world environment, such as a race track (circuit).

In some examples, a representation of the local environment for the event includes position information of static objects (i.e., track). For example, the position information includes latitude, longitude, and elevation of points along the race track. Such points can be obtained from a topographical map, such as Google Earth, and/or any other map source.

In other examples, for situations in which there is a substantial data outage (i.e., where the lost data is more than the latency time so data interpolation is not possible), each affected GPS managed car is temporarily controlled in an autonomous mode by the AI engine. The AI engine translates the car from the last known GPS position to a best path possible (e.g., an ideal path is determined for a given environment, such as a race track, shortest length path, shortest time path, a path defined by waypoints, follow a curve, follow in an inside route of a curve, following an outside route of a curve, etc.), previously determined for the given track, in a frame-by-frame process, continuing with the last known velocity, bearing, and acceleration. The game engine continues to attempt receiving valid data from the server. Once obtained, the AI engine moves the autonomously controlled car in a frame-by-frame process from the base path to the actual position in a smooth and realistic way

In some examples, the system allows one or more end users to access event data from the networked server and to participate in a virtual representation of a physical event including real-world, dynamic objects through insertion of a virtual object. The end user's virtual representation can be accomplished in real-time with the event, or at least near-real time using streaming event data from the networked server. The end user may also choose to participate in a virtual representation of an earlier event using previously recorded data obtaining from the database through the networked server. In either event, the system provides the end user with a realistic experience through the various features described herein, as though the end user were present at the physical event, participating together with the real-world objects.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The client device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for simulating events in a real environment, the method comprising:
determining a user location of a user-controlled object in a virtual environment;
determining a virtual location of a real-data object in the virtual environment relative to the user location based on a real location of the real-data object in the real environment; and
controlling a present virtual location of the real-data object in the virtual environment based on the virtual location and one or more saved real locations associated with the real-data object.

2. The method of claim 1, further comprising:
determining if a next real location of the real-data object is available; and
controlling the present virtual location of the real-data object in the virtual environment based on a pre-defined path associated with the real environment and the determination if the next real location of the real-data object is available.

3. The method of claim 2, further comprising:
determining if an additional real location of the real-data object is available;
identifying a next user location of the user-controlled object in the virtual environment;
determining one or more future virtual locations of the real-data object in the virtual environment based on the determination if the additional real location of the real-data object is available and the next user location, the one or more future virtual locations associated with a path to move the present virtual location to a virtual location associated with the additional real location; and
controlling the present virtual location of the real-data object in the virtual environment based on the one or more future virtual locations.

4. The method of claim 1, further comprising:
identifying a next user location of the user-controlled object in the virtual environment;
determining a next virtual location of the real-data object in the virtual environment based on a next real location of the real-data object in the real environment; and
controlling the present virtual location of the real-data object based on the next virtual location and a realistic distance between the next virtual location and the next user location.

5. The method of claim 4, further comprising determining an additional virtual location of the real-data object in the virtual environment based on the one or more saved real locations.

6. The method of claim 4, further comprising:
identifying an additional user location of the user-controlled object in the virtual environment;
determining a virtual location of a next real-data object in the virtual environment based on a real location of the next real-data object in the real environment; and
controlling a present virtual location of the next real-data object in the virtual environment based on the virtual location, a realistic distance between the virtual location and the additional user location of the user-controlled object, and a time sequence identification associated with the next virtual location of the real-data object.

7. The method of claim 6, further comprising:
determining an additional virtual location of the real-data object in the virtual environment based on the one or more saved locations, the additional virtual location associated with a next time sequence identification; and
determining a next virtual location of the next real-data object in the virtual environment based on one or more next saved locations and the next time sequence identification.

8. The method of claim 1, further comprising:
determining a next virtual location of the real-data object in the virtual environment based on a next real location of the real-data object in the real environment, the next virtual location being different than the next real location and in front of the user-controlled object; and
controlling the present virtual location of the real-data object based on the next virtual location of the real-data object.

9. The method of claim 1, wherein the virtual location of the real-data object in the virtual environment is different than the real location of the real-data object in the real environment.

10. The method of claim 1, further comprising:
determining a virtual location of a next real-data object in the virtual environment relative to the user location of the user-controlled object in the virtual environment based on a real location of the next real-data object in the real environment; and
controlling a present virtual location of the next real-data object in the virtual environment based on the virtual location and one or more saved real locations associated with the next real-data object.

11. The method of claim 1, wherein the determining the virtual location occurs in real-time or near real-time with a movement of the real-data object in the real environment.

12. A method for simulating events in a real environment, the method comprising:
determining a projected intersect between one or more real-world objects and one or more virtual objects in a virtual environment; and
determining an alternative location for each real-world object projected to intersect with at least one virtual object based on the projected intersect between the one or more real-world objects and the one or more virtual objects.

13. The method of claim 12, further comprising positioning each real-world object projected to interest in the respective alternative location.

14. The method of claim 12, further comprising:
determining if a location is missing for the one or more real-world objects; and
determining a missed location for each real-world object missing data based on one or more saved locations associated with the respective real-world object.

15. A method for simulating events in a real environment, the method comprising:
identifying a virtual location and a real-world location for a real-world object;
identifying a virtual location for a virtual object;
determining a projected intersect for the real-world object and the virtual object based on the virtual location for the real-world object, the real-world location for the real-world object, the virtual location for the virtual object, or any combination thereof; and
modifying the virtual location for the real-world object based on the projected intersect and one or more stored virtual locations associated with the real-world object.

16. A computer program product, tangibly embodied in an information carrier, the computer program product including instructions being operable to cause a data processing apparatus to:
determine a user location of a user-controlled object in a virtual environment;
determine a virtual location of a real-data object in the virtual environment relative to the user location based on a real location of the real-data object in the real environment; and
control a present virtual location of the real-data object in the virtual environment based on the virtual location and one or more saved real locations associated with the real-data object.

17. A system for simulating events in a real environment, the system comprising:
a virtual-data location module configured to determine a user location of a user-controlled object in a virtual environment;
a real-data location module configured to determine a virtual location of a real-data object in the virtual environment relative to the user location based on a real location of the real-data object in the real environment; and
a location control module configured to control a present virtual location of the real-data object in the virtual environment based on the virtual location and one or more saved real locations associated with the real-data object.

18. The system of claim 17, further comprising:
the real-data location module further configured to determine if a next real location of the real-data object is available; and
the location control module further configured to control the present virtual location of the real-data object in the virtual environment based on a pre-defined path associated with the real environment and the determination if the next real location of the real-data object is available.

19. The system of claim 18, further comprising:
the real-data location module further configured to determine if an additional real location of the real-data object is available;
the virtual-data location module further configured to identify a next user location of the user-controlled object in the virtual environment;
a location projection module configured to determine one or more future virtual locations of the real-data object in the virtual environment based on the determination if the additional real location of the real-data object is available and the next user location, the one or more future virtual locations associated with a path to move the present virtual location to a virtual location associated with the additional real location; and
the location control module further configured to control the present virtual location of the real-data object in the virtual environment based on the one or more future virtual locations.

20. The system of claim 17, further comprising:
the virtual-data location module further configured to identify a next user location of the user-controlled object in the virtual environment;
the real-data location module further configured to determine a next virtual location of the real-data object in the virtual environment based on a next real location of the real-data object in the real environment; and
the location control module further configured to control the present virtual location of the real-data object based on the next virtual location and a realistic distance between the next virtual location and the next user location.

21. The system of claim 20, further comprising the real-data location module further configured to determine an additional virtual location of the real-data object in the virtual environment based on the one or more saved real locations.

22. The system of claim 20, further comprising:
the virtual-data location module further configured to identify an additional user location of the user-controlled object in the virtual environment;
the real-data location module further configured to determine a virtual location of a next real-data object in the virtual environment based on a real location of the next real-data object in the real environment; and
the location control module further configured to control a present virtual location of the next real-data object in the virtual environment based on the virtual location, a realistic distance between the virtual location and the additional user location of the user-controlled object, and a time sequence identification associated with the next virtual location of the real-data object.

23. The system of claim 22, further comprising:
the real-data location module further configured to:
determine an additional virtual location of the real-data object in the virtual environment based on the one or more saved locations, the additional virtual location associated with a next time sequence identification; and
determine a next virtual location of the next real-data object in the virtual environment based on one or more next saved locations and the next time sequence identification.

24. The system of claim 17, further comprising:
the real-data location module further configured to determine a next virtual location of the real-data object in the virtual environment based on a next real location of the real-data object in the real environment, the next virtual location being different than the next real location and in front of the user-controlled object; and
the location control module further configured to control the present virtual location of the real-data object based on the next virtual location of the real-data object.

25. The system of claim 17, further comprising:
the real-data location module further configured to determine a virtual location of a next real-data object in the virtual environment relative to the user location of the user-controlled object in the virtual environment based on an next real location of the next real-data object in the real environment; and
the location control module further configured to control a present virtual location of the next real-data object in the virtual environment based on the virtual location and one or more saved real locations associated with the next real-data object.

26. A system for simulating events in a real environment, the system comprising:
a location intersect module configured to determine a projected intersect between one or more real-world objects and one or more virtual objects in a virtual environment; and
a location projection module configured to determine an alternative location for each real-world object projected to intersect with at least one virtual object based on the projected intersect between the one or more real-world objects and the one or more virtual objects.

27. The system of claim 26, further comprising a location control module configured to position each real-world object projected to interest in the respective alternative location.

28. The system of claim 26, further comprising:
a real-data location module configured to determine if a location is missing for the one or more real-world objects; and
the location projection module further configured to determine a missed location for each real-world object missing data based on one or more saved locations associated with the respective real-world object.

29. A system for simulating events in a real environment, the system comprising:
a real-data location module configured to identify a virtual location and a real-world location for a real-world object;
a virtual-data location module configured to identify a virtual location for a virtual object;
a location projection module configured to determine a projected intersect for the real-world object and the virtual object based on the virtual location for the real-world object, the real-world location, the virtual location for the virtual object, or any combination thereof; and
a location control module configured to modify the virtual location for the real-world object based on the projected intersect and one or more stored virtual locations associated with the real-world object.

30. A system for simulating events in a real environment, the system comprising:
means for determining a user location of a user-controlled object in a virtual environment;
means for determining a virtual location of a real-data object in the virtual environment relative to the user location based on a real location of the real-data object in the real environment; and
means for controlling a present virtual location of the real-data object in the virtual environment based on the virtual location and one or more saved real locations associated with the real-data object.
